(19) United States
(12) Patent Application Publication
(10) Pub. No.: US 2026/0081076 A1
(43) Pub. Date: Mar. 19, 2026

(54) MULTILAYER CERAMIC CAPACITOR

(71) Applicant: Murata Manufacturing Co., Ltd., Nagaokakyo-shi (JP)

(72) Inventors: Tomohiro SASAKI, Nagaokakyo-shi (JP); Tatsunori YASUDA, Nagaokakyo-shi (JP)

(21) Appl. No.: 19/215,448

(22) Filed: May 22, 2025

(30) Foreign Application Priority Data
Sep. 17, 2024 (JP) 2024-160448

(51) Int. Cl. H01G 4/232; H01G 4/012; H01G 4/33

(52) U.S. Cl. CPC H01G 4/232; H01G 4/012; H01G 4/33

(57) ABSTRACT

A multilayer ceramic capacitor includes a multilayer body including first and second surfaces facing each other in a lamination direction, third and fourth surfaces facing each other in a first direction, and fifth and sixth surfaces facing each other in a second direction, a first outer electrode on the first, third, and fifth surfaces, a second outer electrode on the first, third, and sixth surfaces, a third outer electrode on the first, fourth, and sixth surfaces, and a fourth outer electrode on the first, fourth, and fifth surfaces. The multilayer body includes a first inner electrode exposed on the third surface and connected to the first and third outer electrodes. The first outer electrode includes a notch portion that opens toward the fifth surface, and about 0.85≤L/W≤about 1.0 is satisfied.

### CROSS REFERENCE TO RELATED APPLICATIONS

This application claims the benefit of priority to Japanese Patent Application No. 2024-160448 filed on Sep. 17, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

With the recent reduction in size and thickness of electronic devices such as mobile phones and portable music players, multilayer ceramic capacitors mounted in such smaller and thinner electronic devices have also become smaller and thinner (see, for example, Japanese Unexamined Patent Application Publication No. 2021-101449). In particular, multilayer ceramic capacitors that are becoming thinner are now being used by being embedded in wiring boards, or being mounted in a very narrow gap even when mounted on the surface of a wiring board.

As a multilayer ceramic capacitor that can be made thinner as described above, a multilayer ceramic capacitor described in Japanese Unexamined Patent Application Publication No. 2021-101449 is disclosed. With a square multilayer ceramic capacitor described in Japanese Unexamined Patent Application Publication No. 2021-101449 and the like, outer electrodes are disposed up to ridge portions of side surfaces orthogonal to upper and lower surfaces. Therefore, when such a multilayer ceramic capacitor is mounted using solder, accumulation of the solder near the ridge portions, depending on how the solder spreads, may cause the multilayer ceramic capacitor to rotate, resulting in a mounting failure.

### SUMMARY OF THE INVENTION

Accordingly, example embodiments of the present invention provide multilayer ceramic capacitors each with improved self-alignment properties during mounting.

A multilayer ceramic capacitor according to an example embodiment of the present invention includes a multilayer body including a first surface and a second surface facing each other in a lamination direction, a third surface and a fourth surface facing each other in a first direction orthogonal or substantially orthogonal to the lamination direction, and a fifth surface and a sixth surface facing each other in a second direction orthogonal or substantially orthogonal to the lamination direction and the first direction, a first outer electrode on the first surface, the third surface, and the fifth surface, a second outer electrode on the first surface, the third surface, and the sixth surface, a third outer electrode on the first surface, the fourth surface, and the sixth surface, a fourth outer electrode on the first surface, the fourth surface, and the fifth surface. The multilayer body includes a first inner electrode exposed on the third surface and a surface other than the third surface and connected to the first outer electrode and the third outer electrode, the first outer electrode includes a notch portion that opens toward the fifth surface, and about 0.85≤L/W≤about 1.0 is satisfied, where L is a dimension in the first direction and W is a dimension in the second direction.

In a multilayer ceramic capacitor according to an example embodiment of the present invention, the multilayer body includes the first inner electrode exposed on the third surface and a surface other than the third surface and connected to the first outer electrode and the third outer electrode, the first outer electrode includes the notch portion that opens toward the fifth surface, and about 0.85≤L/W≤about 1.0 is satisfied, where L is a dimension in the first direction and W is a dimension in the second direction. Therefore, it is possible to improve the self-alignment properties during mounting of the multilayer ceramic capacitor.

Example embodiments of the present invention provide multilayer ceramic capacitors each with improved self-alignment properties during mounting.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view from one side showing an example of a multilayer ceramic capacitor according to a first example embodiment of the present invention.

FIG. 2A is a plan view and FIG. 2B is a bottom view showing an example of the multilayer ceramic capacitor according to the first example embodiment of the present invention.

FIG. 3A is a back view, FIG. 3B is a front view, FIG. 3C is a left side view, and FIG. 3D is a right side view showing an example of the multilayer ceramic capacitor according to the first example embodiment of the present invention.

FIG. 4A is a schematic sectional view taken along line IVa-IVa in FIG. 1 and FIG. 4B is a schematic sectional view taken along line IVb-IVb in FIG. 1.

FIG. 5A is a schematic sectional view taken along line VA-VA in FIG. 3A.

FIG. 5B is a schematic sectional view taken along line VB-VB in FIG. 3A.

FIG. 6 is an exploded perspective view of a multilayer body shown in FIG. 1.

FIGS. 7A to 7G are schematic sectional views showing a modification of an inner electrode of the multilayer ceramic capacitor according to the first example embodiment of the present invention.

FIG. 8 is an external perspective view showing an example of a multilayer ceramic capacitor according to Modification 1-A of the first example embodiment of the present invention.

FIG. 9A is a plan view and FIG. 9B is a bottom view showing an example of the multilayer ceramic capacitor according to Modification 1-A of the first example embodiment of the present invention.

FIG. 10A is a back view, FIG. 10B is a front view, FIG. 10C is a left side view, and FIG. 10D is a right side view showing an example of the multilayer ceramic capacitor according to Modification 1-A of the first example embodiment of the present invention.

FIG. 11 is an external perspective view showing an example of a multilayer ceramic capacitor according to Modification 1-B₁ of the first example embodiment of the present invention.

FIG. 12A is a plan view and FIG. 12B is a bottom view showing an example of the multilayer ceramic capacitor according to Modification 1-B₁ of the first example embodiment of the present invention.

FIG. 13A is a back view, FIG. 13B is a front view, FIG. 13C is a left side view, and FIG. 13D is a right side view showing an example of the multilayer ceramic capacitor according to Modification 1-B₁ of the first example embodiment of the present invention.

FIG. 14 is an external perspective view showing an example of a multilayer ceramic capacitor according to Modification 1-B₂ of the first example embodiment of the present invention.

FIG. 15A is a plan view and FIG. 15B is a bottom view showing an example of the multilayer ceramic capacitor according to Modification 1-B₂ of the first example embodiment of the present invention.

FIG. 16A is a back view, FIG. 16B is a front view, FIG. 16C is a left side view, and FIG. 16D is a right side view showing an example of the multilayer ceramic capacitor according to Modification 1-B₂ of the first example embodiment of the present invention.

FIG. 17 is an external perspective view from one side showing an example of a multilayer ceramic capacitor according to Modification 1-C₁ of the first example embodiment of the present invention.

FIG. 18A is a plan view and FIG. 18B is a bottom view showing an example of the multilayer ceramic capacitor according to Modification 1-C₁ of the first example embodiment of the present invention.

FIG. 19A is a back view, FIG. 19B is a front view, FIG. 19C is a left side view, and FIG. 19D is a right side view showing an example of the multilayer ceramic capacitor according to Modification 1-C₁ of the first example embodiment of the present invention.

FIG. 20A is a schematic sectional view taken along line XXa-XXa in FIG. 17 and FIG. 20B is a schematic sectional view taken along line XXb-XXb in FIG. 17.

FIG. 21A is a schematic sectional view taken along line XXIA-XXIA in FIG. 19A.

FIG. 21B is a schematic sectional view taken along line XXIB-XXIB in FIG. 19A.

FIG. 22 is an external perspective view showing an example of a multilayer ceramic capacitor according to Modification 1-C₂ of the first example embodiment of the present invention.

FIG. 23A is a plan view and FIG. 23B is a bottom view showing an example of the multilayer ceramic capacitor according to Modification 1-C₂ of the first example embodiment of the present invention.

FIG. 24A is a back view, FIG. 24B is a front view, FIG. 24C is a left side view, and FIG. 24D is a right side view showing an example of the multilayer ceramic capacitor according to Modification 1-C₂ of the first example embodiment of the present invention.

FIG. 25 is an external perspective view from one side showing an example of a multilayer ceramic capacitor according to Modification 1-D₁ of the first example embodiment of the present invention.

FIG. 26A is a plan view and FIG. 26B is a bottom view showing an example of the multilayer ceramic capacitor according to Modification 1-D₁ of the first example embodiment of the present invention.

FIG. 27A is a back view, FIG. 27B is a front view, FIG. 27C is a left side view, and FIG. 27D is a right side view showing an example of the multilayer ceramic capacitor according to Modification 1-D₁ of the first example embodiment of the present invention.

FIG. 28A is a schematic sectional view taken along line XXVIIIa-XXVIIIa in FIG. 25 and FIG. 28B is a schematic sectional view taken along line XXVIIIb-XXVIIIb in FIG. 25.

FIG. 29A is a schematic sectional view taken along line XXIXA-XXIXA in FIG. 27A.

FIG. 29B is a schematic sectional view taken along line XXIXB-XXIXB in FIG. 27A.

FIG. 30 is an external perspective view showing an example of a multilayer ceramic capacitor according to Modification 1-D₂ of the first example embodiment of the present invention.

FIG. 31A is a plan view and FIG. 31B is a bottom view showing an example of the multilayer ceramic capacitor according to Modification 1-D₂ of the first example embodiment of the present invention.

FIG. 32A is a back view, FIG. 32B is a front view, FIG. 32C is a left side view, and FIG. 32D is a right side view showing an example of the multilayer ceramic capacitor according to Modification 1-D₂ of the first example embodiment of the present invention.

FIG. 33 is an external perspective view from one side showing an example of a multilayer ceramic capacitor according to a second example embodiment of the present invention.

FIG. 34A is a plan view and FIG. 34B is a bottom view showing an example of the multilayer ceramic capacitor according to the second example embodiment of the present invention.

FIG. 35A is a back view, FIG. 35B is a front view, FIG. 35C is a left side view, and FIG. 35D is a right side view showing an example of the multilayer ceramic capacitor according to the second example embodiment of the present invention.

FIG. 36A is a schematic sectional view taken along line XXXVIa-XXXVIa in FIG. 33 and FIG. 36B is a schematic sectional view taken along line XXXVIb-XXXVIb in FIG. 33.

FIG. 37A is a schematic sectional view taken along line XXXVIIA-XXXVIIA in FIG. 35A.

FIG. 37B is a schematic sectional view taken along line XXXVIIB-XXXVIIB in FIG. 35A.

FIG. 38 is an exploded perspective view of a multilayer body shown in FIG. 33.

FIGS. 39A and 39B are schematic sectional views showing a modification of an inner electrode of the multilayer ceramic capacitor according to the second example embodiment of the present invention.

FIG. 40 is an external perspective view showing an example of a multilayer ceramic capacitor according to Modification 2-A of the second example embodiment of the present invention.

FIG. 41A is a plan view and FIG. 41B is a bottom view showing an example of the multilayer ceramic capacitor according to Modification 2-A of the second example embodiment of the present invention.

FIG. 42A is a back view, FIG. 42B is a front view, FIG. 42C is a left side view, and FIG. 42D is a right side view showing an example of the multilayer ceramic capacitor according to Modification 2-A of the second example embodiment of the present invention.

FIG. 43 is an external perspective view showing an example of a multilayer ceramic capacitor according to Modification 2-B₁ of the second example embodiment of the present invention.

FIG. 44A is a plan view and FIG. 44B is a bottom view showing an example of the multilayer ceramic capacitor according to Modification 2-B₁ of the second example embodiment of the present invention.

FIG. 45A is a back view, FIG. 45B is a front view, FIG. 45C is a left side view, and FIG. 45D is a right side view showing an example of the multilayer ceramic capacitor according to Modification 2-B₁ of the second example embodiment of the present invention.

FIG. 46 is an external perspective view showing an example of a multilayer ceramic capacitor according to Modification 2-B₂ of the second example embodiment of the present invention.

FIG. 47A is a plan view and FIG. 47B is a bottom view showing an example of the multilayer ceramic capacitor according to Modification 2-B₂ of the second example embodiment of the present invention.

FIG. 48A is a back view, FIG. 48B is a front view, FIG. 48C is a left side view, and FIG. 48D is a right side view showing an example of the multilayer ceramic capacitor according to Modification 2-B₂ of the second example embodiment of the present invention.

FIG. 49 is an external perspective view showing an example of a multilayer ceramic capacitor according to another modification of an example embodiment of the present invention.

FIG. 50 is a plan view showing an example of a multilayer ceramic capacitor according to another modification of an example embodiment of the present invention.

### DETAILED DESCRIPTION OF THE EXAMPLE EMBODIMENTS

Example embodiments of the present invention will be described in detail below with reference to the drawings.

### A. First Example Embodiment

### 1. Multilayer Ceramic Capacitor

An example of a multilayer ceramic capacitor 10 according to a first example embodiment of the present invention will be described.

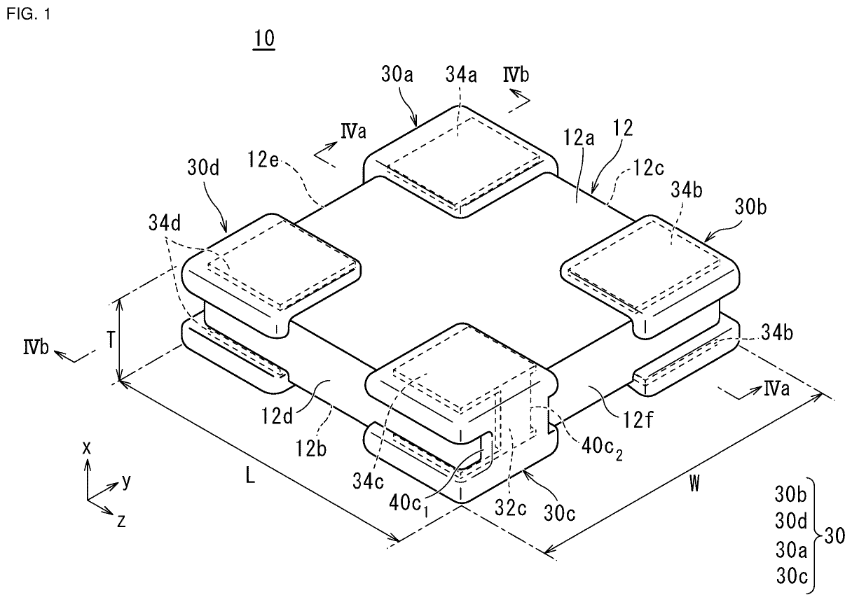

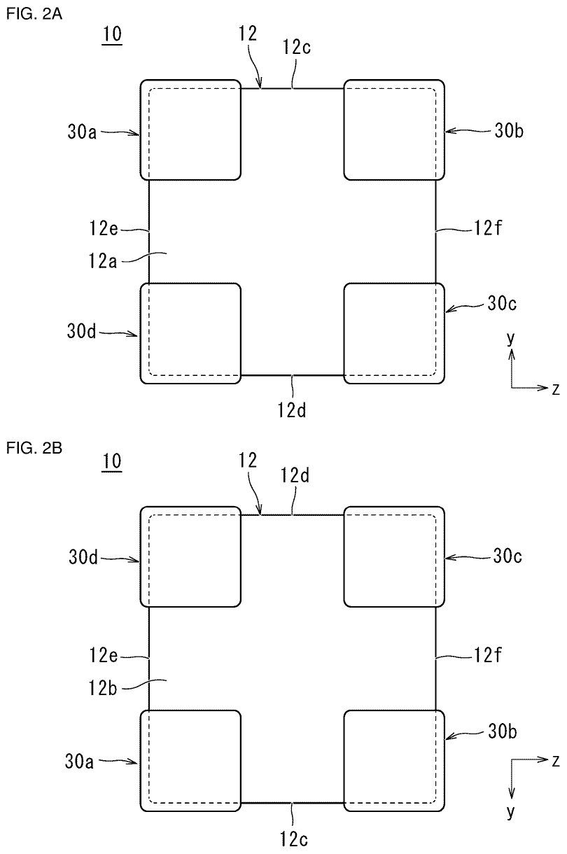

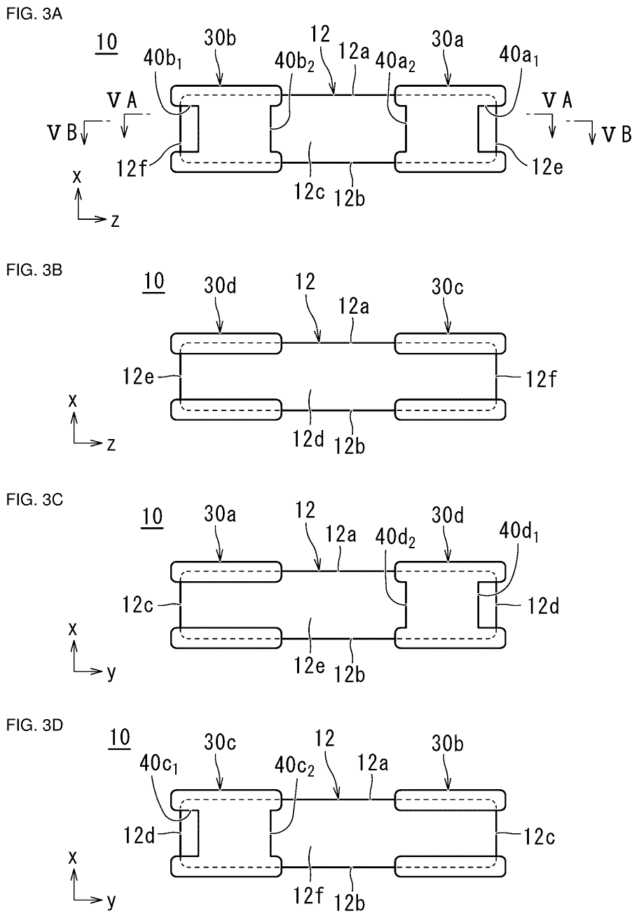

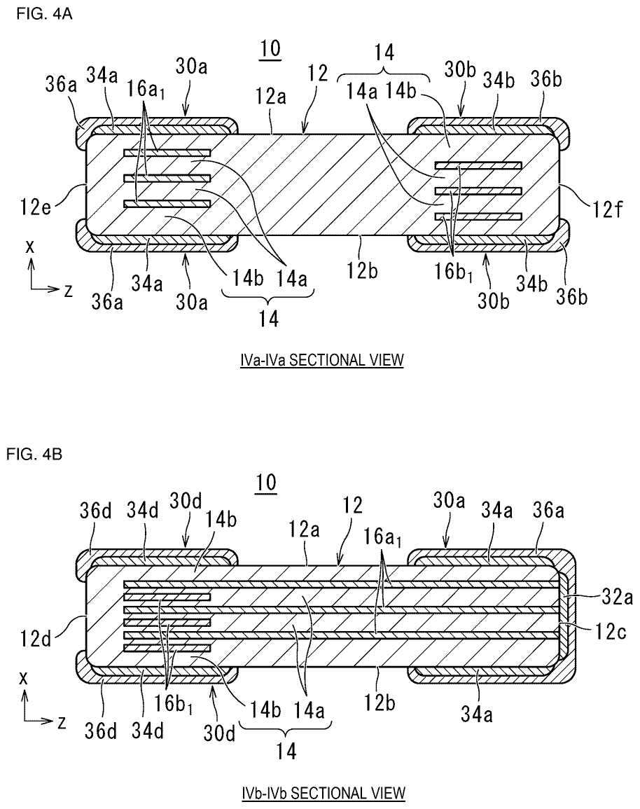

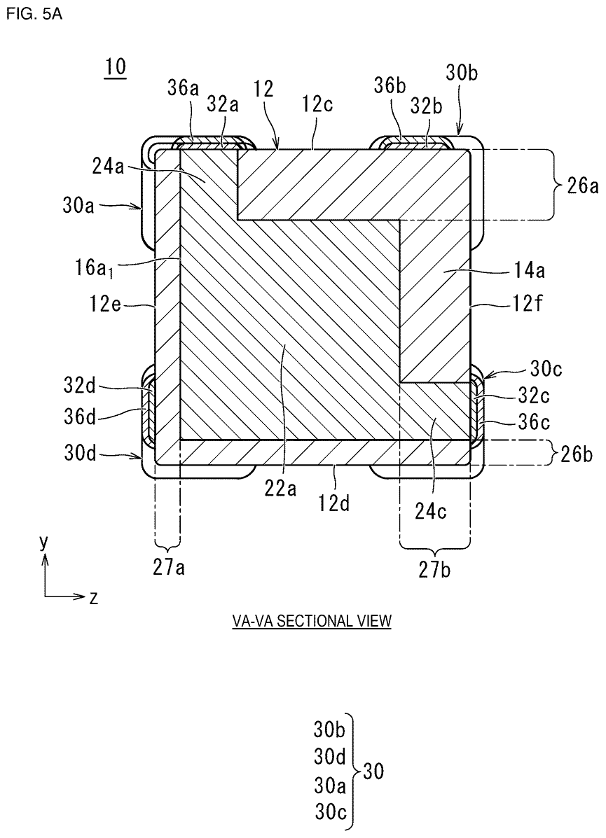

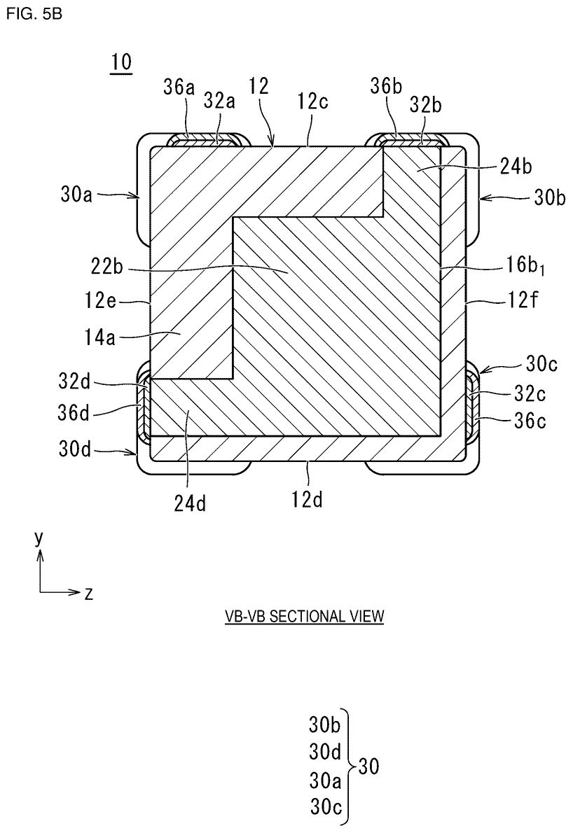

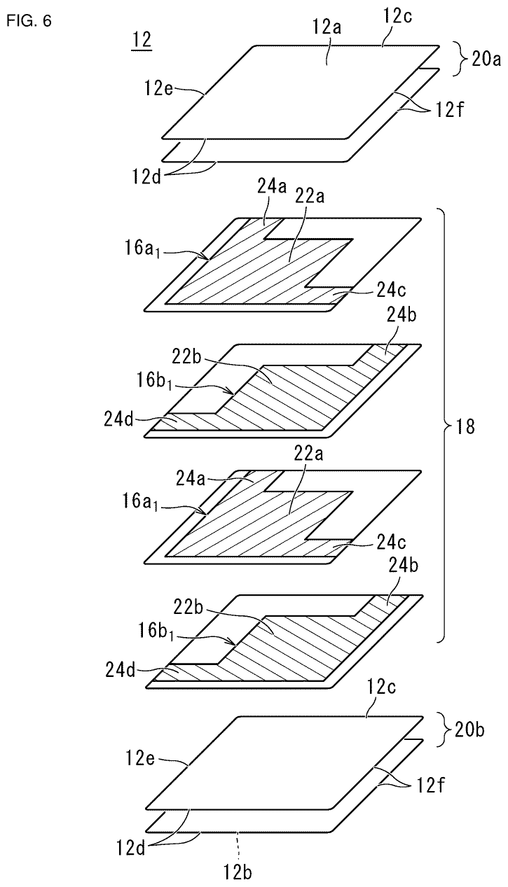

FIG. 1 is an external perspective view from one side showing an example of a multilayer ceramic capacitor according to a first example embodiment of the present invention. FIG. 2A is a plan view and FIG. 2B is a bottom view showing an example of the multilayer ceramic capacitor according to the first example embodiment of the present invention. FIG. 3A is a back view, FIG. 3B is a front view, FIG. 3C is a left side view, and FIG. 3D is a right side view showing an example of the multilayer ceramic capacitor according to the first example embodiment of the present invention. FIG. 4A is a schematic sectional view taken along line IVa-IVa in FIG. 1 and FIG. 4B is a schematic sectional view taken along line IVb-IVb in FIG. 1. FIG. 5A is a schematic sectional view taken along line VA-VA in FIG. 3A. FIG. 5B is a schematic sectional view taken along line VB-VB in FIG. 3A. FIG. 6 is an exploded perspective view of a multilayer body shown in FIG. 1.

The multilayer ceramic capacitor 10 includes a multilayer body 12 and a plurality of outer electrodes 30.

### Multilayer Body

The multilayer body 12 includes a first surface 12a and a second surface 12b facing each other in a lamination direction x, a third surface 12c and a fourth surface 12d facing each other in a first direction y that is orthogonal or substantially orthogonal to the lamination direction x, and a fifth surface 12e and a sixth surface 12f facing each other in a second direction z that is orthogonal or substantially orthogonal to the lamination direction x and the first direction y. The lamination direction x is the direction connecting the first surface 12a and the second surface 12b of the multilayer body 12.

It is preferable that the corners and ridges of the multilayer body 12 are rounded. The corners are the portions where three adjacent surfaces of the multilayer body 12 intersect. The ridges are the portions where two adjacent surfaces of the multilayer body 12 intersect. Furthermore, the third surface 12c and the fourth surface 12d as well as the fifth surface 12e and the sixth surface 12f may have irregularities or the like in a portion or in an entirety thereof.

Either the first surface 12a or the second surface 12b may be roughened.

The multilayer body 12 includes a plurality of dielectric layers 14 and a plurality of inner electrodes 16. The dielectric layers 14 include an inner dielectric layer 14a and an outer dielectric layer 14b. The inner electrodes 16 include a first inner electrode 16a1 and a second inner electrode 16b1.

The multilayer body 12 also includes an inner layer portion 18, a first outer layer portion 20a located on the first surface 12a side, and a second outer layer portion 20b located on the second surface 12b side.

The first outer layer portion 20a is located on the first surface 12a side of the multilayer body 12, and includes the plurality of outer dielectric layers 14b located between the first surface 12a and the inner electrode 16 closest to the first surface 12a.

The second outer layer portion 20b is located on the second surface 12b side of the multilayer body 12, and includes the plurality of outer dielectric layers 14b located between the second surface 12b and the inner electrode 16 closest to the second surface 12b.

The region sandwiched between the first outer layer portion 20a and the second outer layer portion 20b is the inner layer portion 18.

The inner layer portion 18 includes the first inner electrode 16a1 including one end exposed to the third surface 12c and the other end exposed to the sixth surface 12f, the second inner electrode 16b1 including one end exposed to the third surface 12c and the other end exposed to the fifth surface 12e, and the inner dielectric layer 14a.

The dielectric layer 14 can be made of a dielectric material, for example. The dielectric material can be, for example, a dielectric ceramic mainly including BaTiO₃, CaTio₃, SrTiO₃ or CaZrO₃. It is also possible to use a material obtained by adding a sub-component such as, for example, a Mn compound, an Fe compound, a Cr compound, a Co compound or a Ni compound to these main components. The inner dielectric layer 14a and the outer dielectric layer 14b may be made of the same dielectric material, or may be made of different dielectric materials in order to separate the functions of the inner layer portion 18 and the outer layer portions 20a and 20b. At least one of, for example, Si, Mg, Ba, Mn, or the like may be added as an additive.

The inner dielectric layer 14a including, for example, a large amount of CaTiO₃ or CaZrO₃ as a dielectric component can prevent insulation breakdown from occurring between the first inner electrode 16a1 and the second inner electrode 16b1. The inner dielectric layer 14a, without being limited to the above, can also be made mainly of, for example, SrTiO₃ or the like. Alternatively, the inner dielectric layer 14a is preferably made of a material with a high dielectric constant, such as, for example, BaTiO₃, in order to increase the capacitance of the multilayer ceramic capacitor 10.

The dielectric layer 14 can include, for example, a plurality of crystal grains including a perovskite compound with BaTiO₃ as its basic structure.

The thinner the dielectric layer 14, the larger the capacitance of the capacitor. Therefore, the crystal grain size is, for example, preferably smaller than or equal to about 1 μm.

The number of the dielectric layers 14 to be laminated is not particularly limited, but is, for example, preferably 3 to 300, including the first outer layer portion 20a and the second outer layer portion 20b. The thickness of the inner dielectric layer 14a is, for example, preferably about 0.4 μm to about 2.0 μm. The thickness of the outer dielectric layer 14b is, for example, preferably about 2.0 μm to about 100.0 μm.

A dimension L of the multilayer body 12 in the first direction y and a dimension W thereof in the second direction z satisfy, for example, about 0.85≤L/W≤about 1.00, where the first direction y is the direction in which the third surface 12c and the fourth surface 12d face each other and the second direction z is the direction in which the fifth surface 12e and the sixth surface 12f face each other. Specifically, the multilayer body 12 has a tetragonal or substantially tetragonal shape.

### Inner Electrode

The inner electrodes 16 include a plurality of first inner electrodes 16a₁ and a plurality of second inner electrodes 16b₁. The first inner electrodes 16a₁ and the second inner electrodes 16b₁ are alternately laminated with the dielectric layers 14 interposed therebetween.

The first inner electrode 16a₁ is disposed on the surface of the inner dielectric layer 14a. The first inner electrode 16a₁ faces the first surface 12a and the second surface 12b, includes a first counter electrode portion 22a facing the second inner electrode 16b₁, and is laminated in a direction connecting the first surface 12a and the second surface 12b.

The first inner electrode 16a₁ is extended to the third surface 12c of the multilayer body 12 by a first extended electrode portion 24a, and is extended to the sixth surface 12f of the multilayer body 12 by a third extended electrode portion 24c.

The second inner electrode 16b₁ is disposed on a surface of an inner dielectric layer 14a different from the inner dielectric layer 14a on which the first inner electrode 16a₁ is disposed. The second inner electrode 16b₁ faces the first surface 12a and the second surface 12b, includes a second counter electrode portion 22b facing the first inner electrode 16a₁, and is laminated in a direction connecting the first surface 12a and the second surface 12b.

The second inner electrode 16b₁ is extended to the third surface 12c of the multilayer body 12 by a second extended electrode portion 24b, and is extended to the fifth surface 12e of the multilayer body 12 by a fourth extended electrode portion 24d.

When the multilayer ceramic capacitor 10 is viewed from the lamination direction x, a straight line connecting the first extended electrode portion 24a and the third extended electrode portion 24c of the first inner electrode 16a₁ preferably intersects with a straight line connecting the second extended electrode portion 24b and the fourth extended electrode portion 24d of the second inner electrode 16b₁.

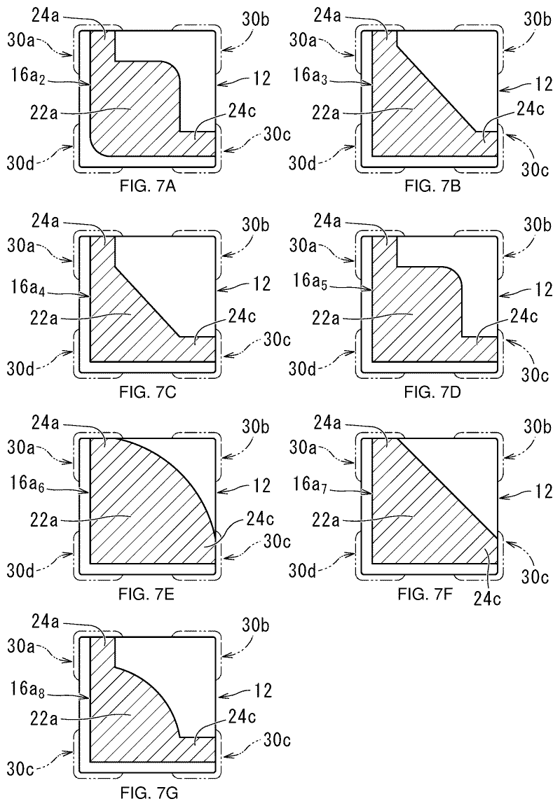

Here, modifications of the shape of the inner electrode 16 will be described. FIGS. 7A to 7G show first inner electrodes 16a₂ to 16a₈ as the modifications of the first inner electrode 16a₁. For the multilayer ceramic capacitor 10 according to example embodiments of the present invention, the first inner electrodes 16a₂ to 16a₈ can be used.

The first inner electrode 16a₂ has an R shape at each corner of the first counter electrode portion 22a where the extended electrode portions 24a and 24c are not disposed.

The first inner electrode 16a₃ and the first inner electrode 16a₄ each include a triangular first counter electrode portion 22a. The first inner electrode 16a₃ and the first inner electrode 16a₄ include extended electrode portions that are different from each other in extension length. The first inner electrode 16a₄ has a longer extension length than the first inner electrode 16a₃.

The first inner electrode 16a₅ includes an R shape only at one of the corners of the first counter electrode portion 22a where the extended electrode portions 24a and 24c are not disposed, which faces the second outer electrode 30b side.

The first inner electrode 16a₆ includes a fan-shaped first counter electrode portion 22a, and the extended electrode portions 24a and 24c of the first inner electrode 16a₆ are a portion of the arc of the fan shape.

The first inner electrode 16a₇ includes a right-angled isosceles triangular first counter electrode portion 22a, and the extended electrode portions 24a and 24c of the first inner electrode 16a₇ are disposed such that the corners of the right-angled isosceles triangle, other than the right-angled corner, are exposed.

The first inner electrode 16a₈ has a fan shape at one of the corners of the first counter electrode portion 22a where the extended electrode portions 24a and 24c are not disposed, which faces the second outer electrode 30b side.

As shown in FIG. 5A, the multilayer body 12 includes a side portion (W gap) 26a of the multilayer body 12 located between one end in the first direction y of the first counter electrode portion 22a of the first inner electrode 16a₁ and the third surface 12c, and a side portion (W gap) 26b of the multilayer body 12 located between the other end in the first direction y of the first counter electrode portion 22a of the first inner electrode 16a₁ and the fourth surface 12d.

As shown in FIG. 5A, the multilayer body 12 further includes an end portion (L gap) 27a of the multilayer body 12 located between one end in the second direction z of the first counter electrode portion 22a of the first inner electrode 16a₁ and the fifth surface 12e, and a side portion (L gap) 27b of the multilayer body 12 located between the other end in the second direction z of the first counter electrode portion 22a of the first inner electrode 16a₁ and the sixth surface 12f.

The first inner electrode 16a₁ and the second inner electrode 16b₁ can be made of, but not limited to, an appropriate conductive material, such as metals such as Ni, Cu, Ag, Pd, or Au, for example, or alloys including at least one of these metals, such as Ni—Cu alloy and Ag—Pd alloy, for example. The first inner electrode 16a₁ and the second inner electrode 16b₁ may be made of the same conductive material, or may be made of different conductive materials.

An Sn layer provided between the first and second inner electrodes 16a₁ and 16b₁ and the inner dielectric layer 14a can reduce electric field concentration at the interface between the inner electrode 16 and the dielectric layer 14. This provides improved high-temperature load reliability.

The total number of the first inner electrodes 16a₁ and the second inner electrodes 16b₁ is, for example, preferably 3 to 300. The thickness of the first inner electrode 16a₁ and the second inner electrode 16b₁ is not particularly limited, but is preferably about 0.2 μm to about 2.0 μm, for example.

The multilayer body 12 of the multilayer ceramic capacitor 10 may have a configuration described below.

In the multilayer ceramic capacitor 10, the third surface 12c to the sixth surface 12f of the multilayer body 12 may be bent so as to be concave toward the center of the multilayer body 12 when viewed in the lamination direction x. In other words, the third surface 12c to the sixth surface 12f of the multilayer body 12 may be warped. In this case, the center of the bend and warpage is preferably near the center of the third surface 12c to the sixth surface 12f. This makes it possible to increase the distance between adjacent outer electrodes 30 to be described later, and thus to reduce or prevent the risk of conduction between the outer electrodes 30.

In addition, when viewed in at least one of the first direction y and the second direction z, the region where the inner electrode 16 is extended onto the third surface 12c to the sixth surface 12f preferably has an R shape from the first surface 12a to the second surface 12b. This increases the exposed area of the inner electrode 16, thus making it possible to improve the contact area between the inner electrode 16 and the outer electrode 30.

### Outer Electrode

As shown in FIGS. 1 to 5B, the outer electrode 30 is disposed on the multilayer body 12.

The outer electrode 30 includes a plurality of outer electrodes 30 connected to the first inner electrode 16a₁ and the second inner electrode 16b₁. The outer electrode 30 includes a first outer electrode 30a, a second outer electrode 30b, a third outer electrode 30c, and a fourth outer electrode 30d.

The first outer electrode 30a is disposed on the third surface 12c so as to cover the first extended electrode portion 24a of the first inner electrode 16a₁, and also to partially cover the first surface 12a and the second surface 12b. The first outer electrode 30a is electrically connected to the first extended electrode portion 24a of the first inner electrode 16a₁.

The first outer electrode 30a includes a notch portion 40a₁ and a notch portion 40a₂ on the third surface 12c. The notch portion 40a₁ opens toward the fifth surface 12e on the third surface 12c. The notch portion 40a₂ opens toward the sixth surface 12f on the third surface 12c.

The second outer electrode 30b is disposed on the third surface 12c so as to cover the second extended electrode portion 24b of the second inner electrode 16b₁, and also to partially cover the first surface 12a and the second surface 12b. The second outer electrode 30b is electrically connected to the second extended electrode portion 24b of the second inner electrode 16b₁.

The second outer electrode 30b includes a notch portion 40b₁ and a notch portion 40b₂ on the third surface 12c. The notch portion 40b₁ opens toward the sixth surface 12f on the third surface 12c. The notch portion 40b₂ opens toward the fifth surface 12e on the third surface 12c.

The third outer electrode 30c is disposed on the sixth surface 12f so as to cover the third extended electrode portion 24c of the first inner electrode 16a₁, and also to partially cover the first surface 12a and the second surface 12b. The third outer electrode 30c is electrically connected to the third extended electrode portion 24c of the first inner electrode 16a₁.

The third outer electrode 30c includes a notch portion 40c₁ and a notch portion 40c₂ on the sixth surface 12f. The notch portion 40c₁ opens toward the fourth surface 12d on the sixth surface 12f. The notch portion 40c₂ opens toward the third surface 12c on the sixth surface 12f.

The fourth outer electrode 30d is disposed on the fifth surface 12e so as to cover the fourth extended electrode portion 24d of the second inner electrode 16b₁, and also to partially cover the first surface 12a and the second surface 12b. The fourth outer electrode 30d is electrically connected to the fourth extended electrode portion 24d of the second inner electrode 16b₁.

The fourth outer electrode 30d includes a notch portion 40d₁ and a notch portion 40d₂ on the fifth surface 12e. The notch portion 40d₁ opens toward the fourth surface 12d on the fifth surface 12e. The notch portion 40d₂ opens toward the third surface 12c on the fifth surface 12e.

In the multilayer body 12, the first counter electrode portion 22a of the first inner electrode 16a₁ and the second counter electrode portion 22b of the second inner electrode 16b₁ face each other across the inner dielectric layer 14a, thus generating an electrostatic capacitance. Therefore, the electrostatic capacitance can be obtained between the first outer electrode 30a and the third outer electrode 30c, to which the first inner electrode 16a₁ is connected, and the second outer electrode 30b and the fourth outer electrode 30d, to which the second inner electrode 16b₁ is connected, thus providing the capacitor characteristics.

The first outer electrode 30a, the second outer electrode 30b, the third outer electrode 30c, and the fourth outer electrode 30d each include an underlying plating layer 32, a thin film layer 34, and a surface plating layer 36.

In other words, the first outer electrode 30a includes a first underlying plating layer 32a, a first thin film layer 34a, and a first surface plating layer 36a. The second outer electrode 30b includes a second underlying plating layer 32b, a second thin film layer 34b, and a second surface plating layer 36b. The third outer electrode 30c includes a third underlying plating layer 32c, a third thin film layer 34c, and a third surface plating layer 36c. The fourth outer electrode 30d includes a fourth underlying plating layer 32d, a fourth thin film layer 34d, and a fourth surface plating layer 36d.

### Underlying Plating Layer

The underlying plating layer 32 is disposed on the third surface 12c, on the fifth surface 12e, and on the sixth surface 12f. A specific configuration of the underlying plating layer 32 will be described below.

The first underlying plating layer 32a is disposed on the third surface 12c of the multilayer body 12 so as to cover the first extended electrode portion 24a of the first inner electrode 16a₁ exposed from the third surface 12c of the multilayer body 12.

The second underlying plating layer 32b is disposed on the third surface 12c of the multilayer body 12 so as to cover the second extended electrode portion 24b of the second inner electrode 16b₁ exposed from the third surface 12c of the multilayer body 12.

The third underlying plating layer 32c is disposed on the sixth surface 12f of the multilayer body 12 so as to cover the third extended electrode portion 24c of the first inner electrode 16a₁ exposed from the sixth surface 12f of the multilayer body 12.

The fourth underlying plating layer 32d is disposed on the fifth surface 12e of the multilayer body 12 so as to cover the fourth extended electrode portion 24d of the second inner electrode 16b₁ exposed from the fifth surface 12e of the multilayer body 12.

### Thin Film Layer

The thin film layer 34 includes the first thin film layer 34a, the second thin film layer 34b, the third thin film layer 34c, and the fourth thin film layer 34d.

The first thin film layer 34a is disposed so as to partially cover the first surface 12a and the second surface 12b of the multilayer body 12 on the third surface 12c side and the fifth surface 12e side, but not to cover the third surface 12c and the fifth surface 12e of the multilayer body 12.

The second thin film layer 34b is disposed so as to partially cover the first surface 12a and the second surface 12b of the multilayer body 12 on the third surface 12c side and the sixth surface 12f side, but not to cover the third surface 12c and the sixth surface 12f.

The third thin film layer 34c is disposed so as to partially cover the first surface 12a and the second surface 12b of the multilayer body 12 on the fourth surface 12d side and the sixth surface 12f side, but not to cover the fourth surface 12d and the sixth surface 12f.

The fourth thin film layer 34d is disposed so as to partially cover the first surface 12a and the second surface 12b of the multilayer body 12 on the fourth surface 12d side and the fifth surface 12e side, but not to cover the fourth surface 12d and the fifth surface 12e.

The first to fourth thin film layers 34a to 34d are each preferably formed by, for example, depositing metal particles by sputtering, vapor deposition or the like. This enables the first to fourth thin film layers 34a to 34d to have a thickness of, for example, smaller than or equal to about 1 μm in the direction connecting the first surface 12a and the second surface 12b of the multilayer body 12. The dimension of the multilayer ceramic capacitor 10 in the lamination direction x can thus be sufficiently reduced, making it possible to reduce the height of the multilayer ceramic capacitor 10.

The dimension of the first to fourth thin film layers 34a to 34d in the lamination direction x can be measured, for example, as follows. Specifically, in the case of forming the thin film layers by depositing metal particles, a fluorescent X-ray device can be used to calculate the thickness from the concentration of a specified element using a calibration curve method for the corresponding metal species. Alternatively, for example, a method can be used in which an FIB cross-section of a component is observed using a scanning microscope, and the thickness is measured from the actual observed image.

When the first to fourth thin film layers 34a to 34d are formed by a thin film formation method, for example, these thin film layers are preferably made of metal such as Cu or Ni.

The thin film layer 34 of the multilayer ceramic capacitor 10 shown in FIG. 1 is formed by, for example, depositing metal particles by sputtering. In this case, when the thickness of the thin film layer 34 is smaller than or equal to about 1 μm, the dimension in the lamination direction x can be sufficiently reduced.

The first to fourth thin film layers 34a to 34d can be configured taking into consideration their respective functions. For example, taking into consideration the adhesion to the multilayer body 12, NiCr or NiCu is preferably used as the main component. Furthermore, for example, the first to fourth thin film layers 34a to 34d may have a multilayer structure such as a two-layer structure including NiCr and NiCu.

The thin film layer 34 may be formed by, for example, screen printing or the like and include a dielectric material and a metal component. In this case, the thin film layer 34 and the ceramic of the multilayer body 12 are fixed to each other, and the fixing strength between the multilayer body 12 and the outer electrode 30 can be further improved. In this case, the thin film layer 34 may also include a ceramic component including the same main component as the inner dielectric layer 14a, in addition to the metal component. The ceramic component included in the thin film layer 34 can reduce the difference in thermal expansion coefficient between the multilayer body 12 and the thin film layer 34, thus reducing the stress applied to the thin film layer 34. However, the metal component may be other metal components, without being limited to Cu and Ni, and, for example, a glass component may be included in addition to the ceramic component. Examples of the glass component include oxides of Ba (barium), Sr (strontium), Si (silicon), Ca (calcium), Zn, Al or B (boron). Examples of other metal components include Mg, Cr, Sr, Al, Na, Fe, or the like. The thin film layer 34 may have a discontinuous shape. The term “discontinuous” means that the thin film layer 34 is formed discontinuously when viewed from a direction perpendicular or substantially perpendicular to the longitudinal direction.

For example, in the case of forming the thin film layer 34 by using a ceramic-including material, for example, a method may be in which a photograph of a cross section is taken using a digital microscope (manufactured by Keyence Corporation: VHX-5000) after polishing the cross section, and then the thickness is calculated from the photograph of the cross section. There is also another method in which the thickness and the like are measured from an actual observed image of an FIB cross-section of a component, using a scanning microscope.

### Surface Plating Layer

The surface plating layer 36 includes a first surface plating layer 36a, a second surface plating layer 36b, a third surface plating layer 36c, and a fourth surface plating layer 36d.

The first surface plating layer 36a is disposed so as to cover the first thin film layer 34a and the first underlying plating layer 32a disposed on the third surface 12c of the multilayer body 12.

The second surface plating layer 36b is disposed so as to cover the second thin film layer 34b and the second underlying plating layer 32b disposed on the third surface 12c of the multilayer body 12.

The third surface plating layer 36c is disposed so as to cover the third thin film layer 34c and the third underlying plating layer 32c disposed on the sixth surface 12f of the multilayer body 12.

The fourth surface plating layer 36d is disposed so as to cover the fourth thin film layer 34d and the fourth underlying plating layer 32d disposed on the fifth surface 12e of the multilayer body 12.

The surface plating layer 36 preferably includes at least one metal of, for example, Cu, Ni, Sn, Pb, Au, Ag, Pd, Bi, Zn, or the like or an alloy including at least one of the metals. The plating layer preferably does not include glass.

The surface plating layer 36 may be only Sn plating, for example, or may be Ni plating, Sn plating, or have a two-layer structure of Ni plating and Cu plating, for example.

The surface plating layer 36 preferably has a thickness of, for example, about 0.5 μm to about 10 μm.

The metal ratio per unit volume of the surface plating layer is, for example, preferably more than or equal to about 99 volume %.

The thickness of each surface plating layer is, for example, preferably about 0.5 μm to about 10.0 μm.

L dimension is the dimension in the first direction y of the multilayer ceramic capacitor 10 including the multilayer body 12 and the outer electrode 30. T dimension is the dimension in the lamination direction x of the multilayer ceramic capacitor 10 including the multilayer body 12 and the outer electrode 30. W dimension is the dimension in the second direction z of the multilayer ceramic capacitor 10 including the multilayer body 12 and the outer electrode 30.

The dimensions of the multilayer ceramic capacitor 10 are, for example, preferably such that the L dimension in the first direction y is about 0.2 mm to about 3.2 mm, the T dimension in the lamination direction x is about 0.04 mm to about 0.22 mm, and the W dimension in the second direction z is about 0.2 mm to about 3.2 mm. The dimensions of the multilayer ceramic capacitor 10 preferably satisfy about 0.85≤L/W≤about 1.00, for example. This enables the multilayer body 12 to have a tetragonal or substantially tetragonal shape, thus improving the degree of freedom of mounting.

In the multilayer ceramic capacitor 10 shown in FIG. 1, the first outer electrode 30a includes the notch portion 40a₁ and the notch portion 40a₂ on the third surface 12c. The notch portion 40a₁ opens toward the fifth surface 12e on the third surface 12c. This makes it possible to improve the self-alignment properties during mounting.

### 2. Modification

### (1) Modification 1-A

Next, an example of a multilayer ceramic capacitor 10A according to Modification 1-A of the first example embodiment of the present invention will be described.

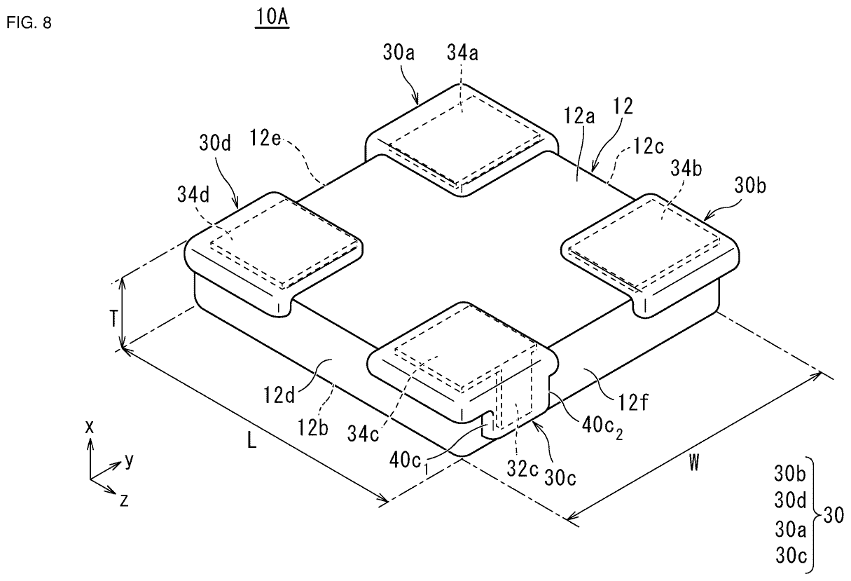

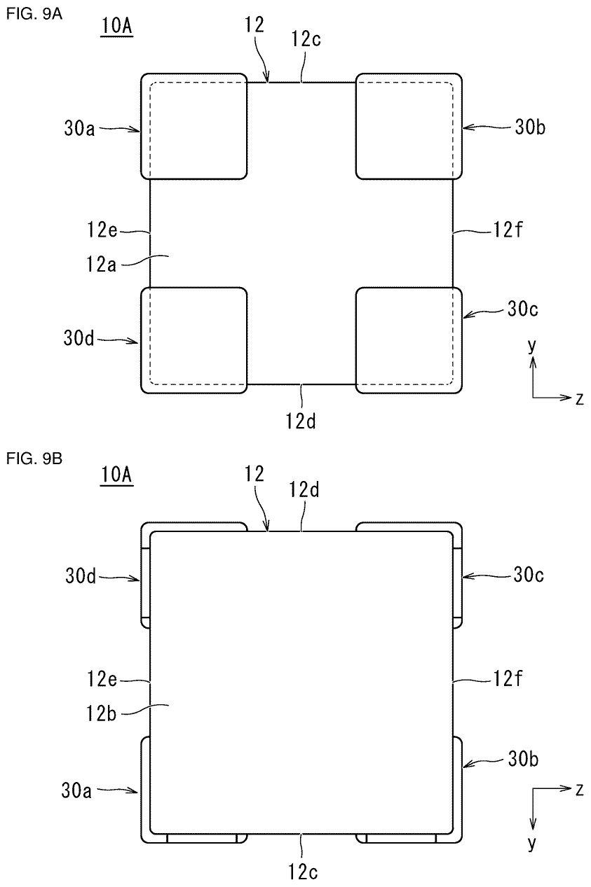

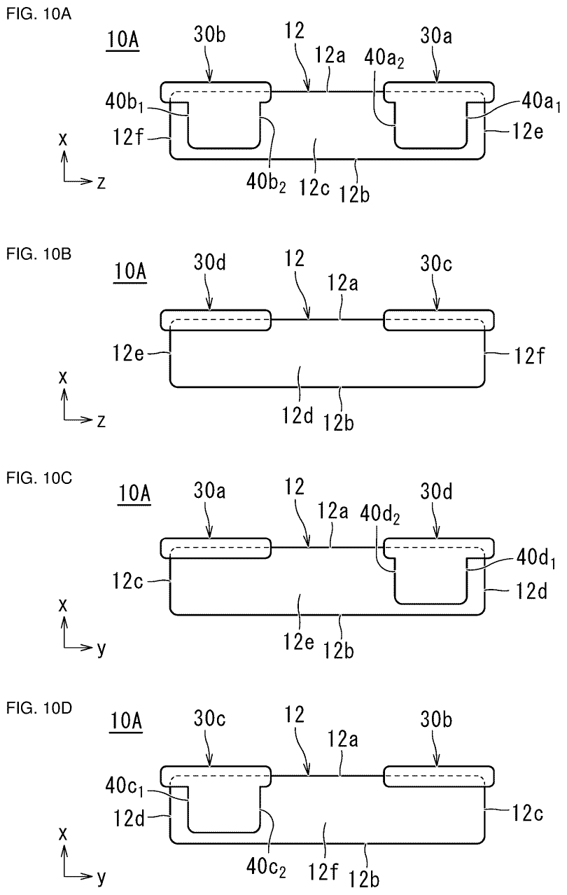

FIG. 8 is an external perspective view showing an example of the multilayer ceramic capacitor according to Modification 1-A of the first example embodiment of the present invention. FIG. 9A is a plan view and FIG. 9B is a bottom view showing an example of the multilayer ceramic capacitor according to Modification 1-A of the first example embodiment of the present invention. FIG. 10A is a back view, FIG. 10B is a front view, FIG. 10C is a left side view, and FIG. 10D is a right side view showing an example of the multilayer ceramic capacitor according to Modification 1-A of the first example embodiment of the present invention. However, the same or corresponding configurations as those in FIGS. 1 to 5B will be denoted by the same reference numerals, and detailed description thereof will be omitted.

The multilayer ceramic capacitor 10A according to Modification 1-A is different from the multilayer ceramic capacitor 10 according to the first example embodiment in the shape of the outer electrode 30. In addition, the outer electrode 30 is not disposed on the second surface 12b.

### Inner Electrode

In the multilayer ceramic capacitor 10A according to Modification 1-A, an inner electrode 16 has the same or substantially the same configuration as that of the inner electrode 16 in the multilayer body 12 of the multilayer ceramic capacitor 10 according to the first example embodiment of the present invention shown in FIG. 1.

### Outer Electrode

As shown in FIGS. 8 to 10, an outer electrode 30 is disposed on a multilayer body 12.

The outer electrode 30 includes a plurality of outer electrodes 30 connected to a first inner electrode 16a₁ and a second inner electrode 16b₁. The outer electrode 30 includes a first outer electrode 30a, a second outer electrode 30b, a third outer electrode 30c, and a fourth outer electrode 30d.

The first outer electrode 30a is disposed on the third surface 12c so as to cover a first extended electrode portion 24a of the first inner electrode 16a₁, and also to partially cover the first surface 12a. The first outer electrode 30a is electrically connected to the first extended electrode portion 24a of the first inner electrode 16a₁.

The first outer electrode 30a includes a notch portion 40a₁ and a notch portion 40a₂ on the third surface 12c. The notch portion 40a₁ opens toward the fifth surface 12e and the second surface 12b on the third surface 12c. The notch portion 40a₂ opens toward the sixth surface 12f and the second surface 12b on the third surface 12c.

The second outer electrode 30b is disposed on the third surface 12c so as to cover a second extended electrode portion 24b of the second inner electrode 16b₁, and also to partially cover the first surface 12a. The second outer electrode 30b is electrically connected to the second extended electrode portion 24b of the second inner electrode 16b₁.

The second outer electrode 30b includes a notch portion 40b₁ and a notch portion 40b₂ on the third surface 12c. The notch portion 40b₁ opens toward the sixth surface 12f and the second surface 12b on the third surface 12c. The notch portion 40b₂ opens toward the fifth surface 12e and the second surface 12b on the third surface 12c.

The third outer electrode 30c is disposed on the sixth surface 12f so as to cover a third extended electrode portion 24c of the first inner electrode 16a₁, and also to partially cover the first surface 12a. The third outer electrode 30c is electrically connected to the third extended electrode portion 24c of the first inner electrode 16a₁.

The third outer electrode 30c includes a notch portion 40c₁ and a notch portion 40c₂ on the sixth surface 12f. The notch portion 40c₁ opens toward the fourth surface 12d and the second surface 12b on the sixth surface 12f. The notch portion 40c₂ opens toward the third surface 12c and the second surface 12b on the sixth surface 12f.

The fourth outer electrode 30d is disposed on the fifth surface 12e so as to cover a fourth extended electrode portion 24d of the second inner electrode 16b₁, and also to partially cover the first surface 12a. The fourth outer electrode 30d is electrically connected to the fourth extended electrode portion 24d of the second inner electrode 16b₁.

The fourth outer electrode 30d includes a notch portion 40d₁ and a notch portion 40d₂ on the fifth surface 12e. The notch portion 40d₁ opens toward the fourth surface 12d and the second surface 12b on the fifth surface 12e. The notch portion 40d₂ opens toward the third surface 12c and the second surface 12b on the fifth surface 12e.

The first outer electrode 30a, the second outer electrode 30b, the third outer electrode 30c, and the fourth outer electrode 30d each include an underlying plating layer 32, a thin film layer 34, and a surface plating layer 36.

In other words, the first outer electrode 30a includes a first underlying plating layer 32a, a first thin film layer 34a, and a first surface plating layer 36a. The second outer electrode 30b includes a second underlying plating layer 32b, a second thin film layer 34b, and a second surface plating layer 36b. The third outer electrode 30c includes a third underlying plating layer 32c, a third thin film layer 34c, and a third surface plating layer 36c. The fourth outer electrode 30d includes a fourth underlying plating layer 32d, a fourth thin film layer 34d, and a fourth surface plating layer 36d.

The multilayer ceramic capacitor 10A shown in FIG. 8 has the same effect as that of the multilayer ceramic capacitor 10 according to the first example embodiment.

### (2) Modification 1-B₁

Next, an example of a multilayer ceramic capacitor 10B₁ according to Modification 1-B₁ of the first example embodiment of the present invention will be described.

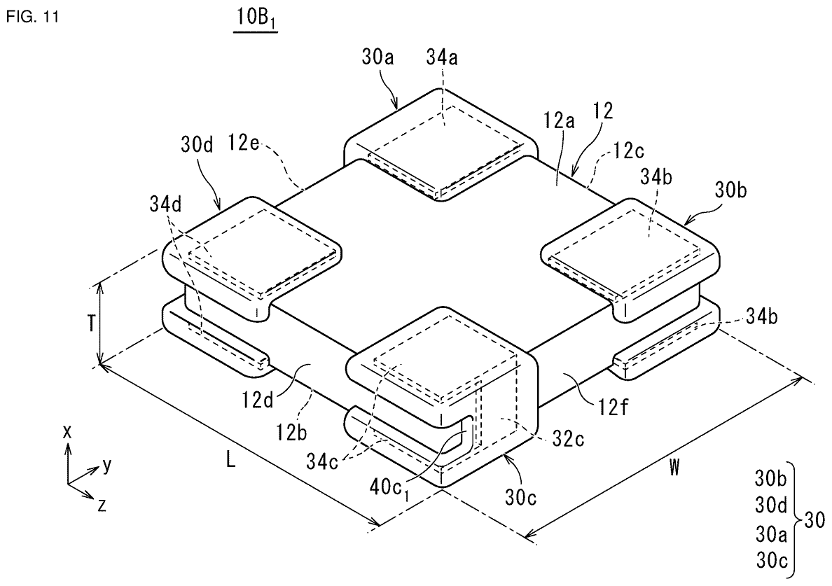

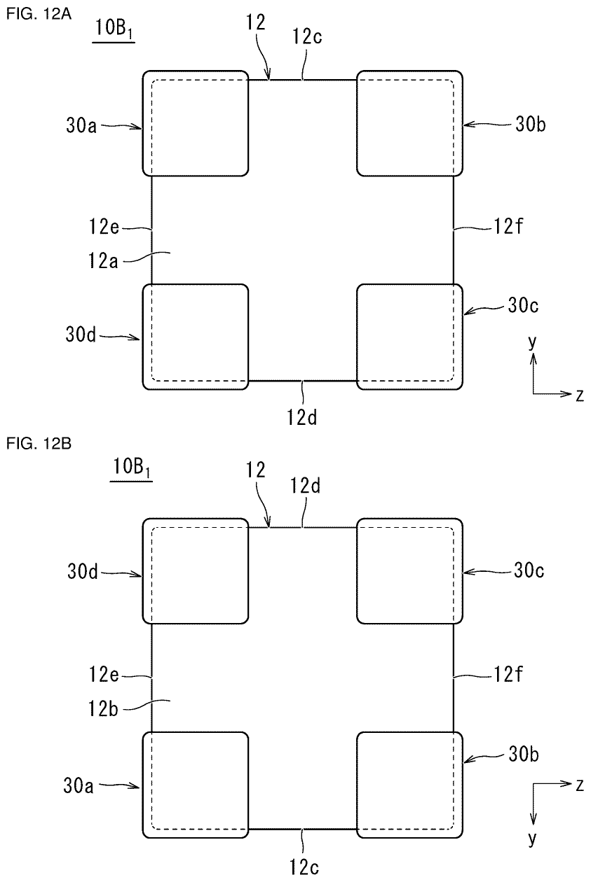

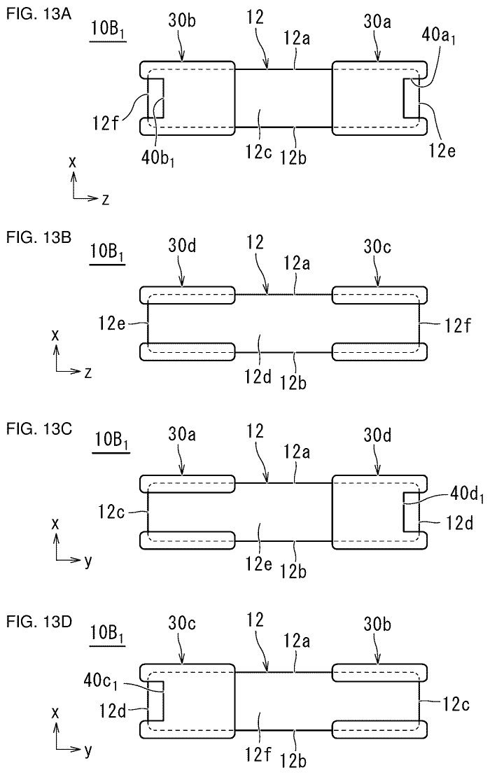

FIG. 11 is an external perspective view showing an example of the multilayer ceramic capacitor according to Modification 1-B₁ of the first example embodiment of the present invention. FIG. 12A is a plan view and FIG. 12B is a bottom view showing an example of the multilayer ceramic capacitor according to Modification 1-B₁ of the first example embodiment of the present invention. FIG. 13A is a back view, FIG. 13B is a front view, FIG. 13C is a left side view, and FIG. 13D is a right side view showing an example of the multilayer ceramic capacitor according to Modification 1-B₁ of the first example embodiment of the present invention.

The multilayer ceramic according to Modification 1-B₁ is different from the multilayer ceramic capacitor 10 according to the first example embodiment in the shape of the outer electrode 30.

### Inner Electrode

In the multilayer ceramic capacitor 10B₁ according to Modification 1-B₁, an inner electrode 16 has the same or substantially the same configuration as that of the inner electrode 16 in the multilayer body 12 of the multilayer ceramic capacitor 10 according to the first example embodiment of the present invention shown in FIG. 1.

### Outer Electrode

As shown in FIGS. 11 to 13, an outer electrode 30 is disposed on a multilayer body 12.

The outer electrode 30 includes a plurality of outer electrodes 30 connected to a first inner electrode 16a₁ and a second inner electrode 16b₁. The outer electrode 30 includes a first outer electrode 30a, a second outer electrode 30b, a third outer electrode 30c, and a fourth outer electrode 30d.

The first outer electrode 30a is disposed on the third surface 12c so as to cover a first extended electrode portion 24a of a first inner electrode 16a₁, and also to partially cover the first surface 12a and the second surface 12b. The first outer electrode 30a is electrically connected to the first extended electrode portion 24a of the first inner electrode 16a₁.

The first outer electrode 30a includes a notch portion 40a₁ on the third surface 12c. The notch portion 40a₁ opens toward the fifth surface 12e on the third surface 12c.

The second outer electrode 30b is disposed on the third surface 12c so as to cover a second extended electrode portion 24b of a second inner electrode 16b₁, and also to partially cover the first surface 12a and the second surface 12b. The second outer electrode 30b is electrically connected to the second extended electrode portion 24b of the second inner electrode 16b₁.

The second outer electrode 30b includes a notch portion 40b₁ on the third surface 12c. The notch portion 40b₁ opens toward the sixth surface 12f on the third surface 12c.

The third outer electrode 30c is disposed on the sixth surface 12f so as to cover a third extended electrode portion 24c of the first inner electrode 16a₁, and also to partially cover the first surface 12a and the second surface 12b. The third outer electrode 30c is electrically connected to the third extended electrode portion 24c of the first inner electrode 16a₁.

The third outer electrode 30c includes a notch portion 40c₁ on the sixth surface 12f. The notch portion 40c₁ opens toward the fourth surface 12d on the sixth surface 12f.

The fourth outer electrode 30d is disposed on the fifth surface 12e so as to cover a fourth extended electrode portion 24d of the second inner electrode 16b₁, and also to partially cover the first surface 12a and the second surface 12b. The fourth outer electrode 30d is electrically connected to the fourth extended electrode portion 24d of the second inner electrode 16b₁.

The fourth outer electrode 30d includes a notch portion 40d₁ on the fifth surface 12e. The notch portion 40d₁ opens toward the fourth surface 12d on the fifth surface 12e.

The multilayer ceramic capacitor 10B₁ shown in FIG. 11 has the same or substantially the same advantageous effects as those of the multilayer ceramic capacitor 10 according to the first example embodiment.

### (3) Modification 1-B₂

Next, an example of a multilayer ceramic capacitor 10B according to Modification 1-B₂ of the first example embodiment of the present invention will be described.

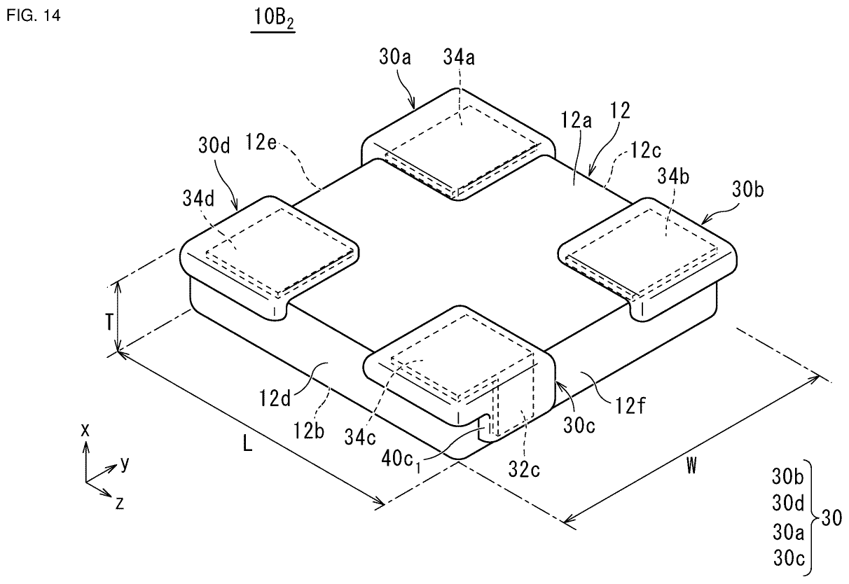

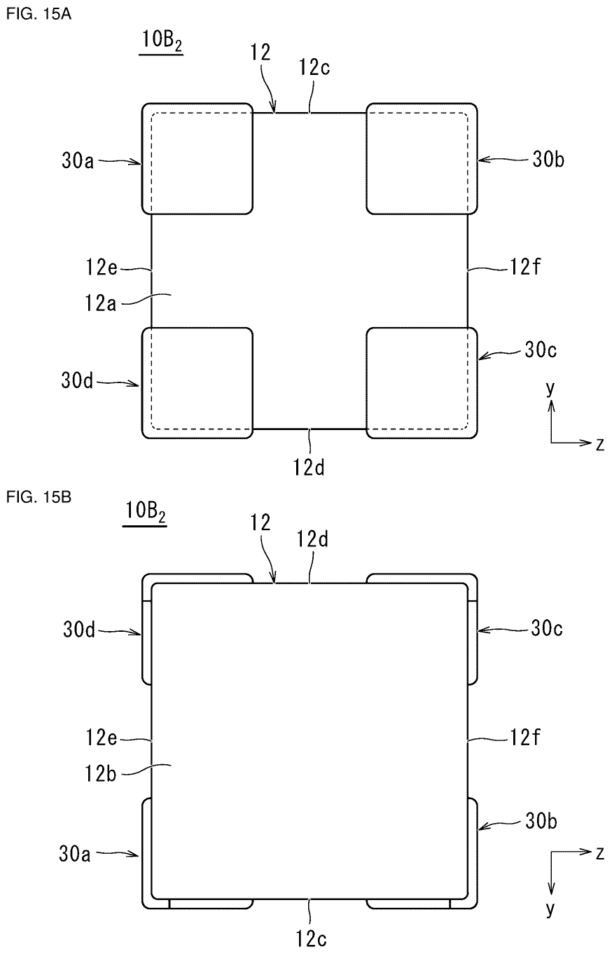

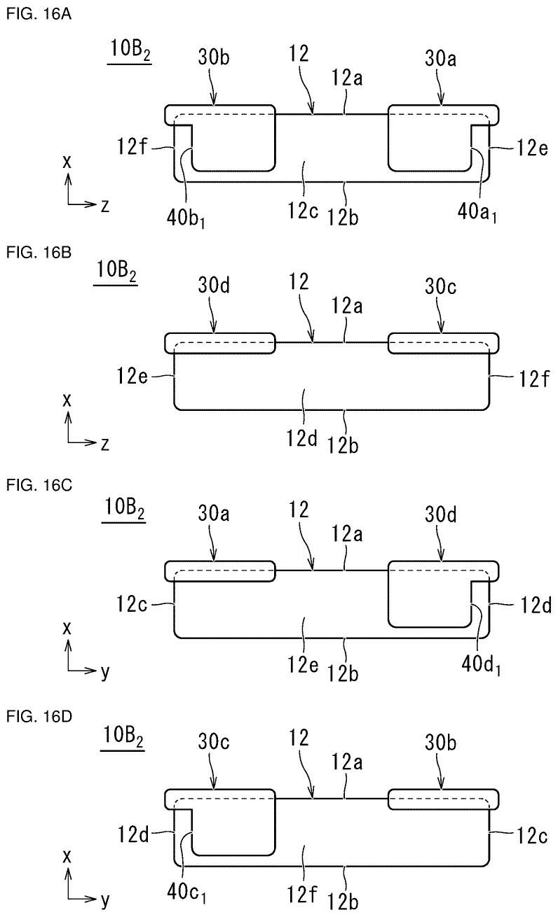

FIG. 14 is an external perspective view showing an example of the multilayer ceramic capacitor according to Modification 1-B₂ of the first example embodiment of the present invention. FIG. 15A is a plan view and FIG. 15B is a bottom view showing an example of the multilayer ceramic capacitor according to Modification 1-B₂ of the first example embodiment of the present invention. FIG. 16A is a back view, FIG. 16B is a front view, FIG. 16C is a left side view, and FIG. 16D is a right side view showing an example of the multilayer ceramic capacitor according to Modification 1-B₂ of the first example embodiment of the present invention. However, the same or corresponding configurations as those in FIGS. 1 to 5B will be denoted by the same reference numerals, and detailed description thereof will be omitted.

The multilayer ceramic capacitor 10B₂ according to Modification 1-B₂ is different from the multilayer ceramic capacitor 10 according to the first example embodiment in the shape of the outer electrode 30. In addition, the outer electrode 30 is not disposed on the second surface 12b.

### Inner Electrode

In the multilayer ceramic capacitor 10B₂ according to Modification 1-B₂, an inner electrode 16 has the same or substantially the same configuration as that of the inner electrode 16 in the multilayer body 12 of the multilayer ceramic capacitor 10 according to the first example embodiment of the present invention shown in FIG. 1.

### Outer Electrode

As shown in FIGS. 14 to 16, an outer electrode 30 is disposed on a multilayer body 12.

The outer electrode 30 includes a plurality of outer electrodes 30 connected to a first inner electrode 16a₁ and a second inner electrode 16b₁. The outer electrode 30 includes a first outer electrode 30a, a second outer electrode 30b, a third outer electrode 30c, and a fourth outer electrode 30d.

The first outer electrode 30a is disposed on the third surface 12c so as to cover a first extended electrode portion 24a of the first inner electrode 16a₁, and also to partially cover the first surface 12a. The first outer electrode 30a is electrically connected to the first extended electrode portion 24a of the first inner electrode 16a₁.

The first outer electrode 30a includes a notch portion 40a₁ on the third surface 12c. The notch portion 40a₁ opens toward the fifth surface 12e and the second surface 12b on the third surface 12c.

The second outer electrode 30b is disposed on the third surface 12c so as to cover a second extended electrode portion 24b of the second inner electrode 16b₁, and also to partially cover the first surface 12a. The second outer electrode 30b is electrically connected to the second extended electrode portion 24b of the second inner electrode 16b₁.

The second outer electrode 30b includes a notch portion 40b₁ on the third surface 12c. The notch portion 40b₁ opens toward the sixth surface 12f and the second surface 12b on the third surface 12c.

The third outer electrode 30c is disposed on the sixth surface 12f so as to cover a third extended electrode portion 24c of the first inner electrode 16a₁, and also to partially cover the first surface 12a. The third outer electrode 30c is electrically connected to the third extended electrode portion 24c of the first inner electrode 16a₁.

The third outer electrode 30c includes a notch portion 40c₁ on the sixth surface 12f. The notch portion 40c₁ opens toward the fourth surface 12d and the second surface 12b on the sixth surface 12f.

The fourth outer electrode 30d is disposed on the fifth surface 12e so as to cover a fourth extended electrode portion 24d of the second inner electrode 16b₁, and also to partially cover the first surface 12a. The fourth outer electrode 30d is electrically connected to the fourth extended electrode portion 24d of the second inner electrode 16b₁.

The fourth outer electrode 30d includes a notch portion 40d₁ on the fifth surface 12e. The notch portion 40d₁ opens toward the fourth surface 12d and the second surface 12b on the fifth surface 12e.

The multilayer ceramic capacitor 10B₂ shown in FIG. 14 has the same or substantially the same advantageous effects as those of the multilayer ceramic capacitor 10 according to the first example embodiment.

### (4) Modification 1-C₁

Next, an example of a multilayer ceramic capacitor 10C₁ according to Modification 1-C₁ of the first example embodiment of the present invention will be described.

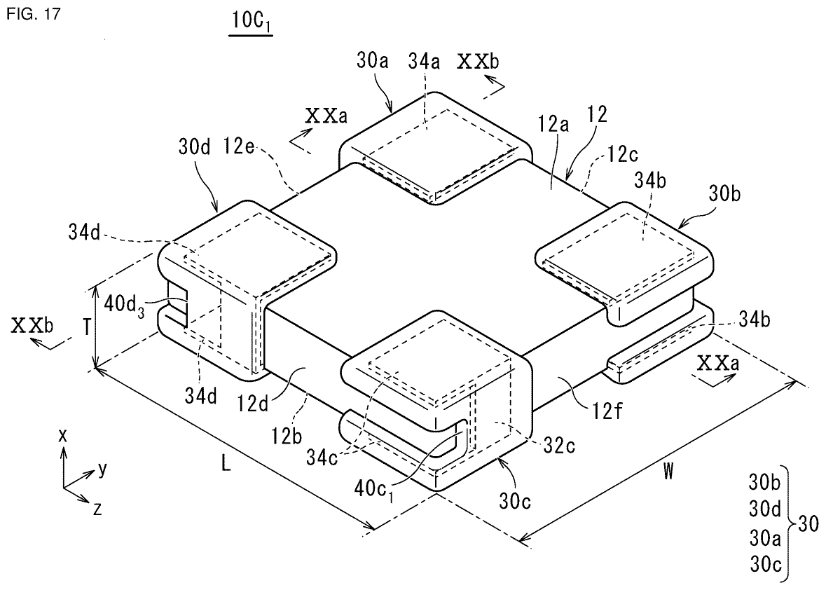

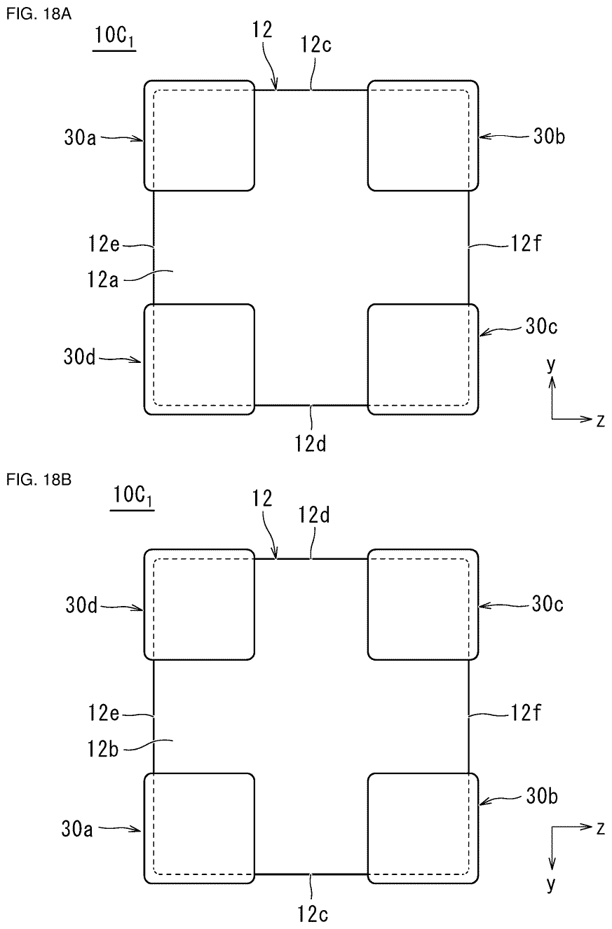

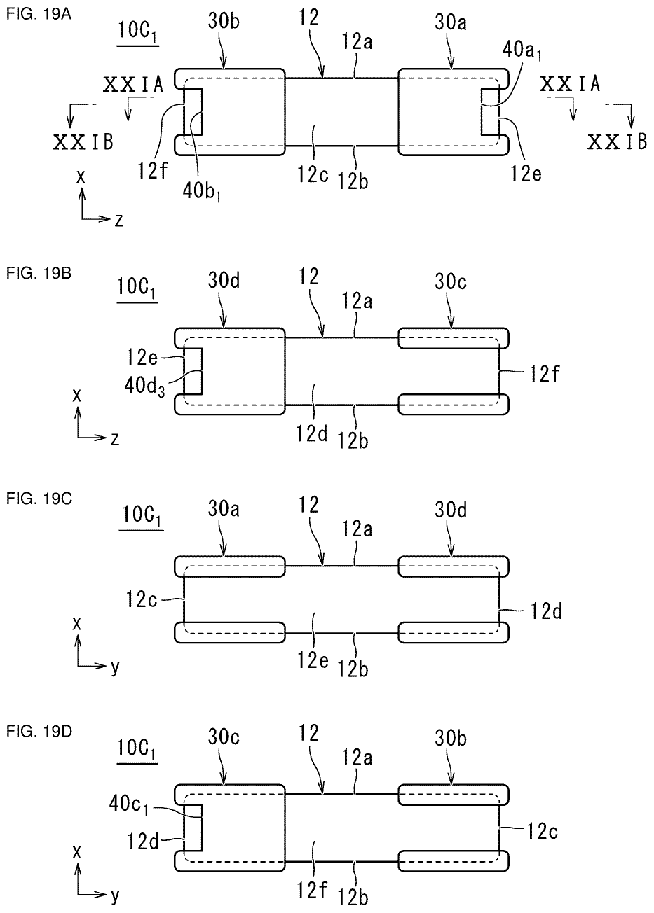

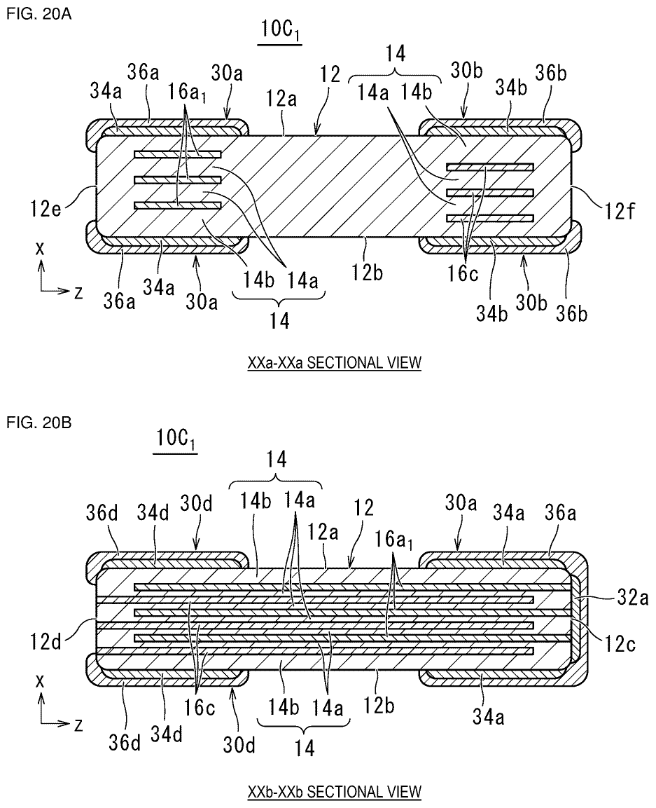

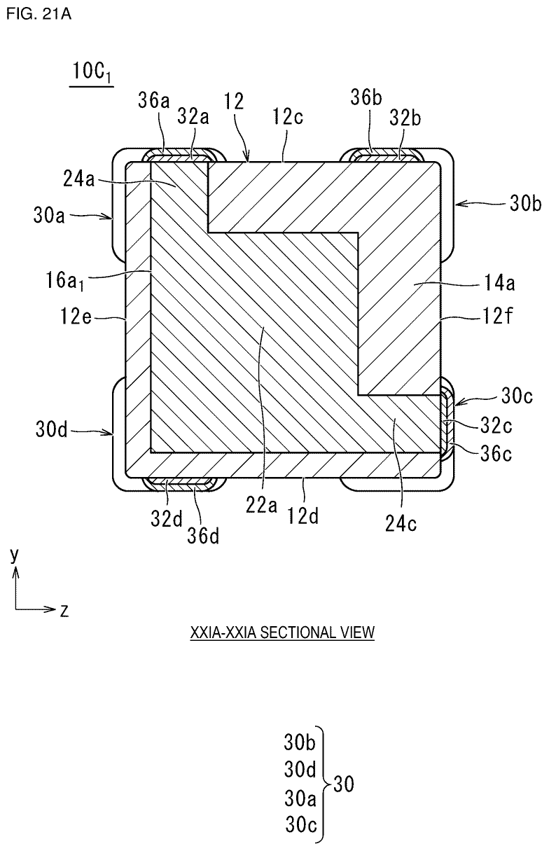

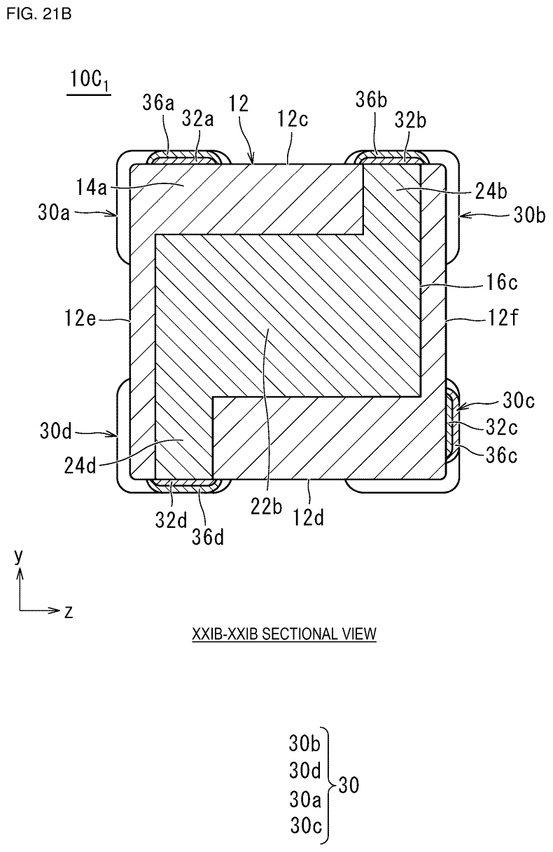

FIG. 17 is an external perspective view from one side showing an example of the multilayer ceramic capacitor according to Modification 1-C₁ of the first example embodiment of the present invention. FIG. 18A is a plan view and FIG. 18B is a bottom view showing an example of the multilayer ceramic capacitor according to Modification 1-C₁ of the first example embodiment of the present invention. FIG. 19A is a back view, FIG. 19B is a front view, FIG. 19C is a left side view, and FIG. 19D is a right side view showing an example of the multilayer ceramic capacitor according to Modification 1-C₁ of the first example embodiment of the present invention. FIG. 20A is a schematic sectional view taken along line XXa-XXa in FIG. 17. FIG. 20B is a schematic sectional view taken along line XXb-XXb in FIG. 17. FIG. 21A is a schematic sectional view taken along line XXIA-XXIA in FIG. 19A. FIG. 21B is a schematic sectional view taken along line XXIB-XXIB in FIG. 19A. However, the same or corresponding configurations as those in FIGS. 1 to 5B will be denoted by the same reference numerals, and detailed description thereof will be omitted.

The multilayer ceramic capacitor 10C₁ according to Modification 1-C₁ is different from the multilayer ceramic capacitor 10 according to the first example embodiment in the shape of the outer electrode 30.

### Inner Electrode

In the multilayer ceramic capacitor 10C₁ according to Modification 1-C₁, an inner electrode 16 has the same or substantially the same configuration as that of the first inner electrode 16a₁ of the inner electrode 16 in the multilayer body 12 of the multilayer ceramic capacitor 10 according to the first example embodiment of the present invention shown in FIG. 1.

A second inner electrode 16c is extended to the third surface 12c of the multilayer body 12 by a second extended electrode portion 24b, and is extended to the fourth surface 12d of the multilayer body 12 by a fourth extended electrode portion 24d.

### Outer Electrode

As shown in FIGS. 17 to 21B, an outer electrode 30 is disposed on a multilayer body 12.

The outer electrode 30 includes a plurality of outer electrodes 30 connected to the first inner electrode 16a₁ and the second inner electrode 16c. The outer electrode 30 includes a first outer electrode 30a, a second outer electrode 30b, a third outer electrode 30c, and a fourth outer electrode 30d.

The first outer electrode 30a is disposed on the third surface 12c so as to cover a first extended electrode portion 24a of the first inner electrode 16a₁, and also to partially cover the first surface 12a and the second surface 12b. The first outer electrode 30a is electrically connected to the first extended electrode portion 24a of the first inner electrode 16a₁.

The first outer electrode 30a includes a notch portion 40a₁ on the third surface 12c. The notch portion 40a₁ opens toward the fifth surface 12e on the third surface 12c.

The second outer electrode 30b is disposed on the third surface 12c so as to cover the second extended electrode portion 24b of the second inner electrode 16c, and also to partially cover the first surface 12a and the second surface 12b. The second outer electrode 30b is electrically connected to the second extended electrode portion 24b of the second inner electrode 16c.

The second outer electrode 30b includes a notch portion 40b₁ on the third surface 12c. The notch portion 40b₁ opens toward the sixth surface 12f on the third surface 12c.

The third outer electrode 30c is disposed on the sixth surface 12f so as to cover a third extended electrode portion 24c of the first inner electrode 16a₁, and also to partially cover the first surface 12a and the second surface 12b. The third outer electrode 30c is electrically connected to the third extended electrode portion 24c of the first inner electrode 16a₁.

The third outer electrode 30c includes a notch portion 40c₁ on the sixth surface 12f. The notch portion 40c₁ opens toward the fourth surface 12d on the sixth surface 12f.

The fourth outer electrode 30d is disposed on the fourth surface 12d so as to cover the fourth extended electrode portion 24d of the second inner electrode 16c, and also to partially cover the first surface 12a and the second surface 12b. The fourth outer electrode 30d is electrically connected to the fourth extended electrode portion 24d of the second inner electrode 16c.

The fourth outer electrode 30d includes a notch portion 40d₃ on the fourth surface 12d. The notch portion 40d₃ opens toward the fifth surface 12e on the fourth surface 12d.

The multilayer ceramic capacitor 10C₁ shown in FIG. 17 has the same or substantially the same advantageous effects as those of the multilayer ceramic capacitor 10 according to the first example embodiment.

### (5) Modification 1-C₂

Next, an example of a multilayer ceramic capacitor 10C₂ according to Modification 1-C₂ of the first example embodiment of the present invention will be described.

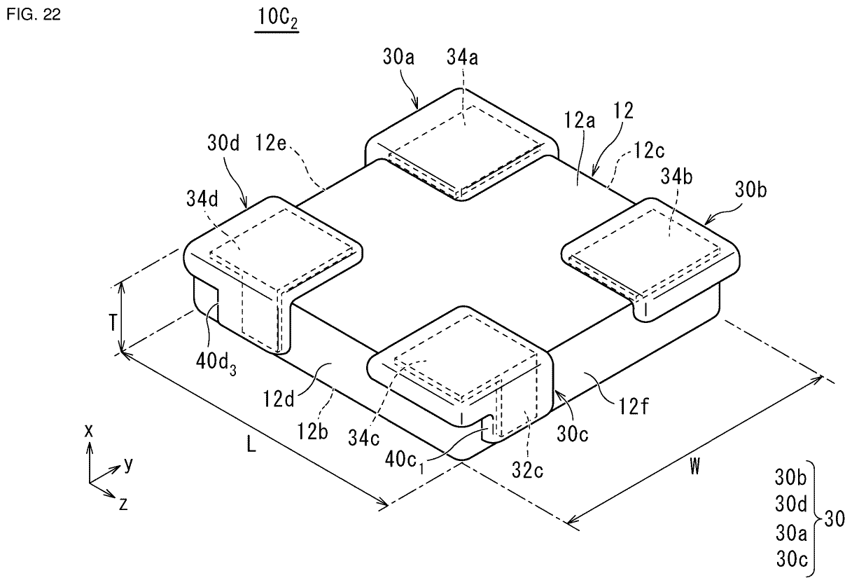

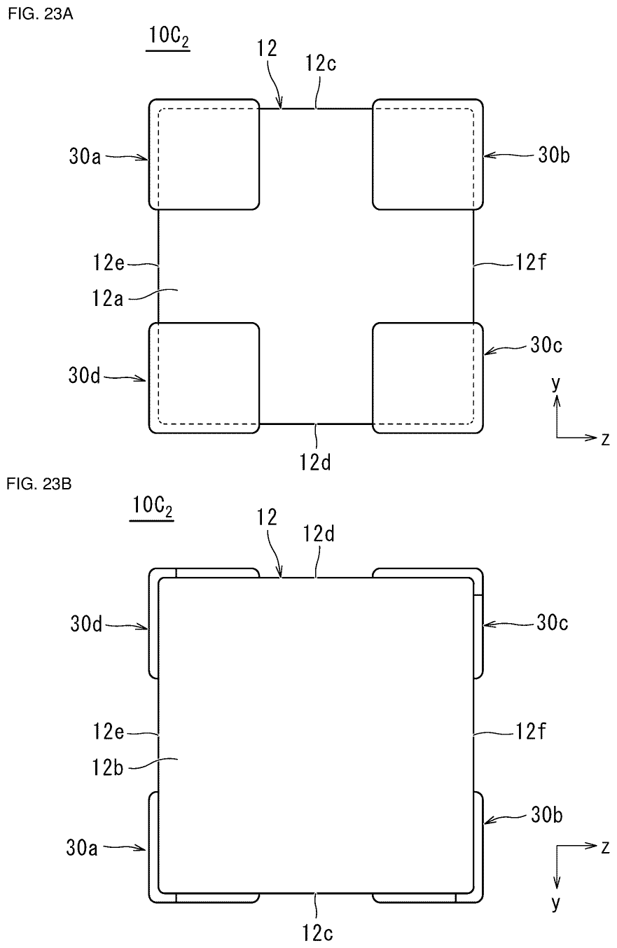

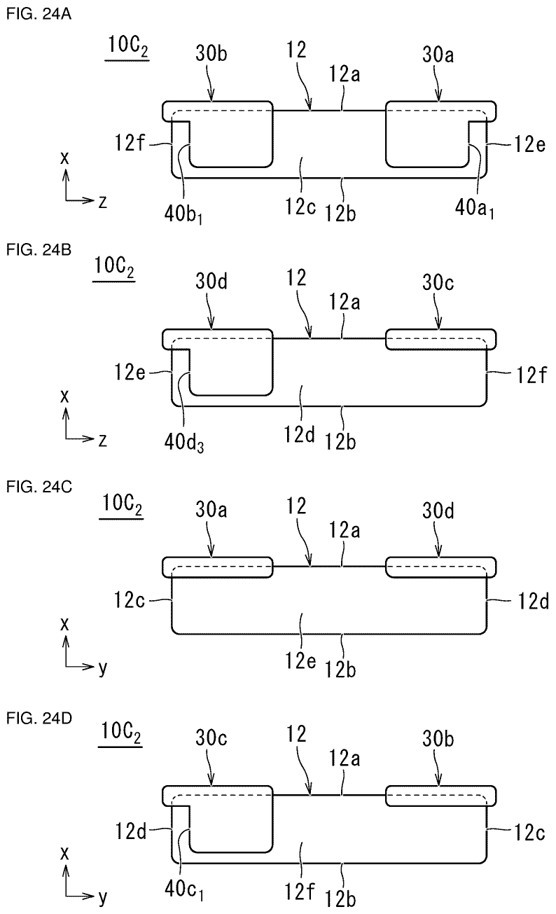

FIG. 22 is an external perspective view showing an example of the multilayer ceramic capacitor according to Modification 1-C₂ of the first example embodiment of the present invention. FIG. 23A is a plan view and FIG. 23B is a bottom view showing an example of the multilayer ceramic capacitor according to Modification 1-C₂ of the first example embodiment of the present invention. FIG. 24A is a back view, FIG. 24B is a front view, FIG. 24C is a left side view, and FIG. 24D is a right side view showing an example of the multilayer ceramic capacitor according to Modification 1-C₂ of the first example embodiment of the present invention. However, the same or corresponding configurations as those in FIGS. 1 to 5B will be denoted by the same reference numerals, and detailed description thereof will be omitted.

The multilayer ceramic capacitor 10C₂ according to Modification 1-C₂ is different: from the multilayer ceramic capacitor 10 according to the first example embodiment in the shape of the outer electrode 30. In addition, the outer electrode 30 is not disposed on the second surface 12b.

### Inner Electrode

In the multilayer ceramic capacitor 10C₂ according to Modification 1-C₂, an inner electrode 16 has the same or substantially the same configuration as that of the inner electrode 16 in the multilayer body 12 of the multilayer ceramic capacitor 10C₁ according to Modification 1-C₁ of the first example embodiment of the present invention shown in FIG. 17.

### Outer Electrode

As shown in FIGS. 22 to 24, an outer electrode 30 is disposed on a multilayer body 12.

The outer electrode 30 includes a plurality of outer electrodes 30 connected to a first inner electrode 16a₁ and a second inner electrode 16c. The outer electrode 30 includes a first outer electrode 30a, a second outer electrode 30b, a third outer electrode 30c, and a fourth outer electrode 30d.

The first outer electrode 30a is disposed on the third surface 12c so as to cover a first extended electrode portion 24a of the first inner electrode 16a₁, and also to partially cover the first surface 12a. The first outer electrode 30a is electrically connected to the first extended electrode portion 24a of the first inner electrode 16a₁.

The first outer electrode 30a includes a notch portion 40a₁ on the third surface 12c. The notch portion 40a₁ opens toward the fifth surface 12e and the second surface 12b on the third surface 12c.

The second outer electrode 30b is disposed on the third surface 12c so as to cover a second extended electrode portion 24b of the second inner electrode 16c, and also to partially cover the first surface 12a. The second outer electrode 30b is electrically connected to the second extended electrode portion 24b of the second inner electrode 16c.

The second outer electrode 30b includes a notch portion 40b₁ on the third surface 12c. The notch portion 40b₁ opens toward the sixth surface 12f and the second surface 12b on the third surface 12c.

The third outer electrode 30c is disposed on the sixth surface 12f so as to cover a third extended electrode portion 24c of the first inner electrode 16a₁, and also to partially cover the first surface 12a. The third outer electrode 30c is electrically connected to the third extended electrode portion 24c of the first inner electrode 16a₁.

The third outer electrode 30c includes a notch portion 40c₁ on the sixth surface 12f. The notch portion 40c₁ opens toward the fourth surface 12d and the second surface 12b on the sixth surface 12f.

The fourth outer electrode 30d is disposed on the fourth surface 12d so as to cover a fourth extended electrode portion 24d of the second inner electrode 16c, and also to partially cover the first surface 12a. The fourth outer electrode 30d is electrically connected to the fourth extended electrode portion 24d of the second inner electrode 16c.

The fourth outer electrode 30d includes a notch portion 40d₃ on the fourth surface 12d. The notch portion 40d₃ opens toward the fifth surface 12e and the second surface 12b on the fourth surface 12d.

The multilayer ceramic capacitor 10C₂ shown in FIG. 22 has the same or substantially the same advantageous effects as those of the multilayer ceramic capacitor 10 according to the first example embodiment.

### (6) Modification 1-D₁

Next, an example of a multilayer ceramic capacitor 10D₁ according to Modification 1-D₁ of the first example embodiment of the present invention will be described.

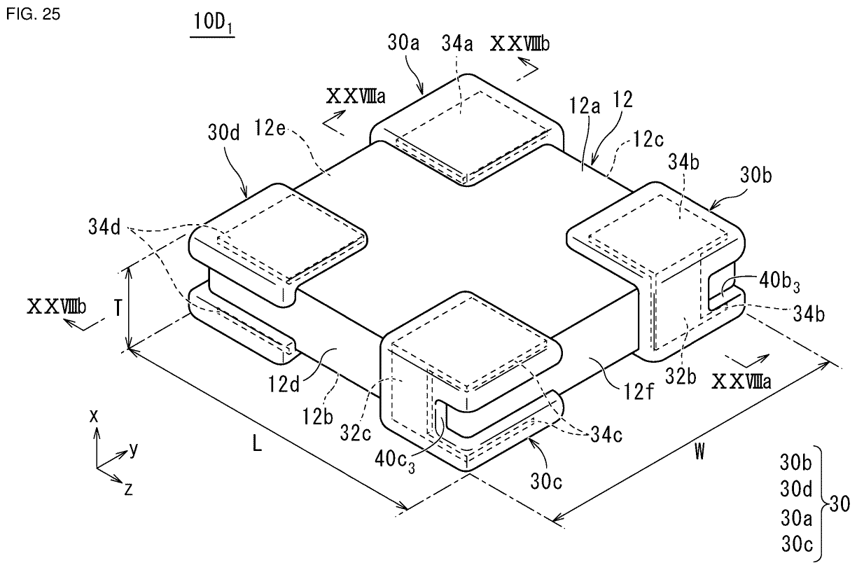

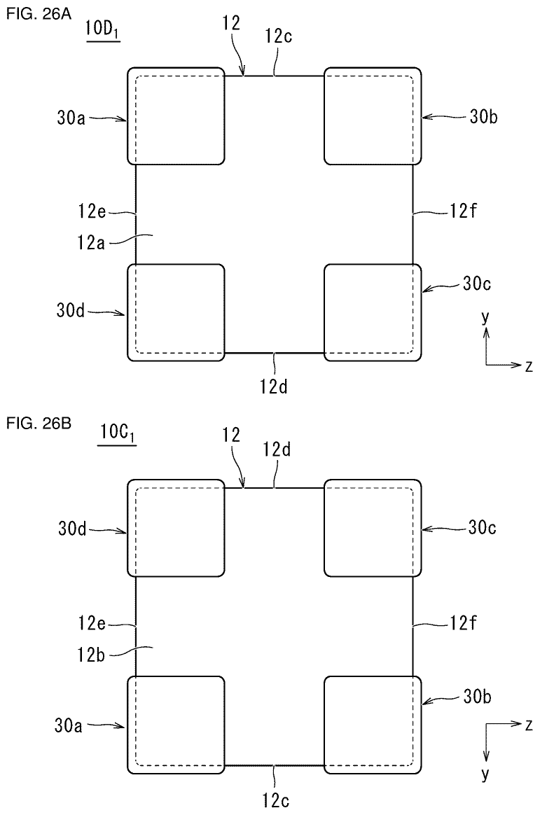

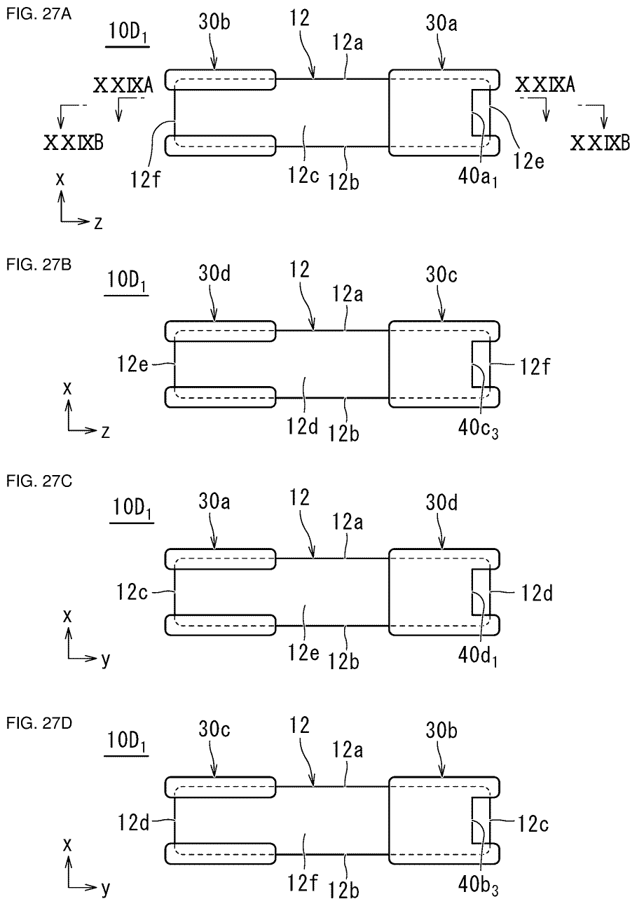

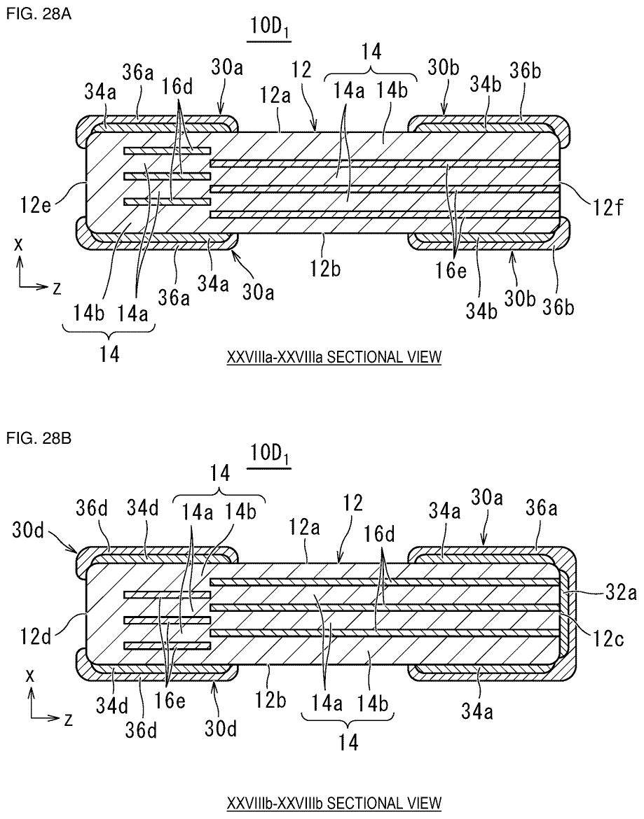

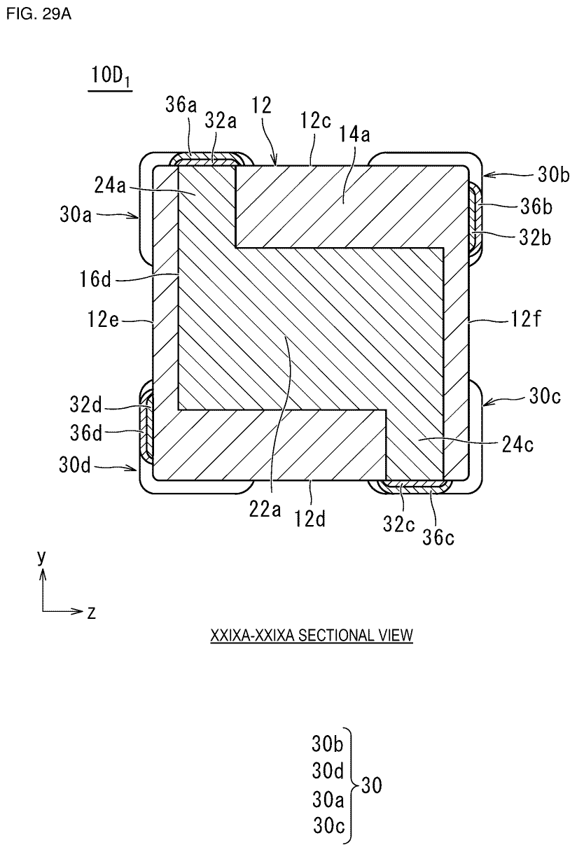

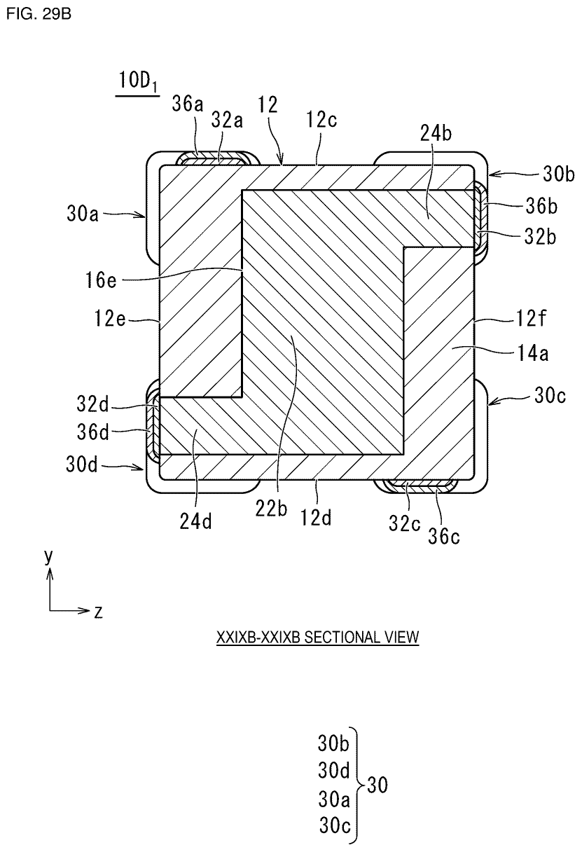

FIG. 25 is an external perspective view from one side showing an example of a multilayer ceramic capacitor according to Modification 1-D₁ of the first example embodiment of the present invention. FIG. 26A is a plan view and FIG. 26B is a bottom view showing an example of the multilayer ceramic capacitor according to Modification 1-D₁ of the first example embodiment of the present invention. FIG. 27A is a back view, FIG. 27B is a front view, FIG. 27C is a left side view, and FIG. 27D is a right side view showing an example of the multilayer ceramic capacitor according to Modification 1-D₁ of the first example embodiment of the present invention. FIG. 28A is a schematic sectional view taken along line XXVIIIa-XXVIIIa in FIG. 25 and FIG. 28B is a schematic sectional view taken along line XXVIIIb-XXVIIIb in FIG. 25. FIG. 29A is a schematic sectional view taken along line XXIXA-XXIXA in FIG. 27A. FIG. 29B is a schematic sectional view taken along line XXIXB-XXIXB in FIG. 27A. However, the same or corresponding configurations as those in FIGS. 1 to 5B will be denoted by the same reference numerals, and detailed description thereof will be omitted.

The multilayer ceramic capacitor 10D₁ according to Modification 1-D₁ is different from the multilayer ceramic capacitor 10 according to the first example embodiment in the shape of the outer electrode 30.

### Inner Electrode

An inner electrode 16 includes a plurality of first inner electrodes 16d and a plurality of second inner electrodes 16e. The first inner electrodes 16d and the second inner electrodes 16e are alternately laminated with dielectric layers 14 interposed therebetween.

The first inner electrode 16d is extended to a third surface 12c of a multilayer body 12 by a first extended electrode portion 24a, and is extended to a fourth surface 12d of the multilayer body 12 by a third extended electrode portion 24c.

The second inner electrode 16e is extended to the sixth surface 12f of the multilayer body 12 by a second extended electrode portion 24b, and is extended to a fifth surface 12e of the multilayer body 12 by a fourth extended electrode portion 24d.

### Outer Electrode

As shown in FIGS. 25 to 29B, an outer electrode 30 is disposed on the multilayer body 12.

The outer electrode 30 includes a plurality of outer electrodes 30 connected to the first inner electrode 16d and the second inner electrode 16e. The outer electrode 30 includes a first outer electrode 30a, a second outer electrode 30b, a third outer electrode 30c, and a fourth outer electrode 30d.

The first outer electrode 30a is disposed on the third surface 12c so as to cover the first extended electrode portion 24a of the first inner electrode 16d, and also to partially cover the first surface 12a and the second surface 12b. The first outer electrode 30a is electrically connected to the first extended electrode portion 24a of the first inner electrode 16d.

The first outer electrode 30a includes a notch portion 40a₁ on the third surface 12c. The notch portion 40a₁ opens toward the fifth surface 12e on the third surface 12c.

The second outer electrode 30b is disposed on the sixth surface 12f so as to cover the second extended electrode portion 24b of the second inner electrode 16e, and also to partially cover the first surface 12a and the second surface 12b. The second outer electrode 30b is electrically connected to the second extended electrode portion 24b of the second inner electrode 16e.

The second outer electrode 30b includes a notch portion 40b₃ on the sixth surface 12f. The notch portion 40b₃ opens toward the third surface 12c on the sixth surface 12f.

The third outer electrode 30c is disposed on the fourth surface 12d so as to cover the third extended electrode portion 24c of the first inner electrode 16d, and also to partially cover the first surface 12a and the second surface 12b. The third outer electrode 30c is electrically connected to the third extended electrode portion 24c of the first inner electrode 16d.

The third outer electrode 30c includes a notch portion 40C3 on the fourth surface 12d. The notch portion 40c₃ opens toward the sixth surface 12f on the fourth surface 12d.

The fourth outer electrode 30d is disposed on the fifth surface 12e so as to cover the fourth extended electrode portion 24d of the second inner electrode 16e, and also to partially cover the first surface 12a and the second surface 12b. The fourth outer electrode 30d is electrically connected to the fourth extended electrode portion 24d of the second inner electrode 16e. The fourth outer electrode 30d includes a notch portion 40d₁ on the fifth surface 12e. The notch portion 40d₁ opens toward the fourth surface 12d on the fifth surface 12e.

The multilayer ceramic capacitor 10Di shown in FIG. 25 has the same or substantially the same advantageous effects as those of the multilayer ceramic capacitor 10 according to the first example embodiment.

### (5) Modification 1-D₂

Next, an example of a multilayer ceramic capacitor 10D₂ according to Modification 1-D₂ of the first example embodiment of the present invention will be described.

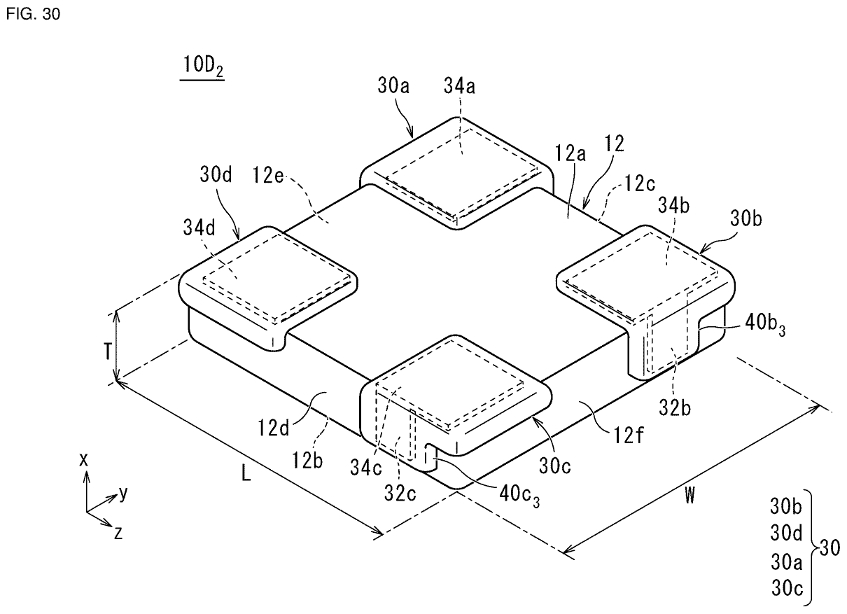

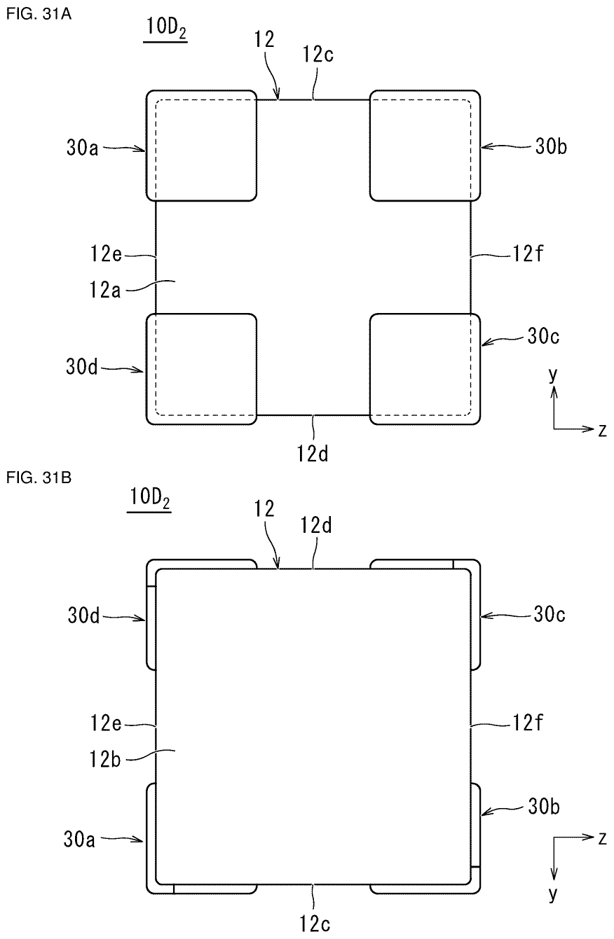

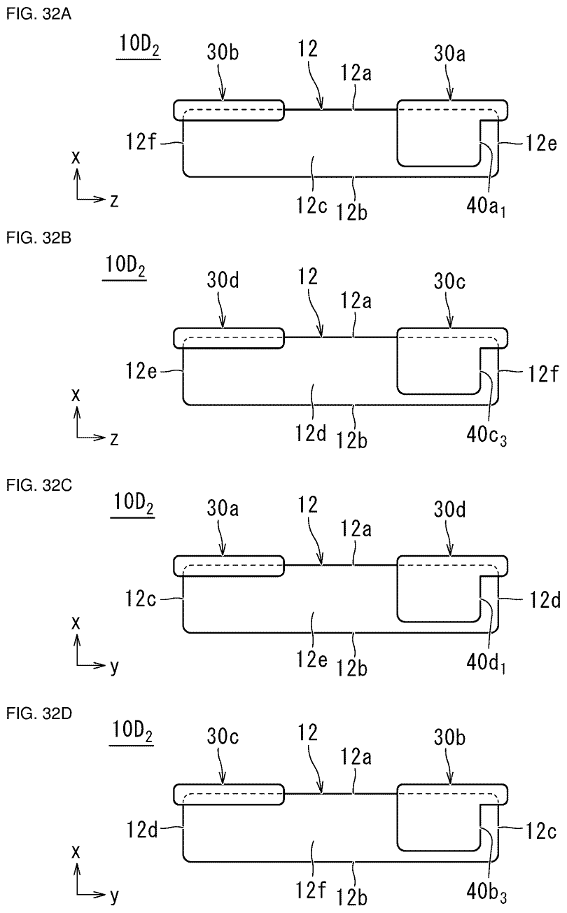

FIG. 30 is an external perspective view showing an example of the multilayer ceramic capacitor according to Modification 1-D₂ of the first example embodiment of the present invention. FIG. 31A is a plan view and FIG. 31B is a bottom view showing an example of the multilayer ceramic capacitor according to Modification 1-D₂ of the first example embodiment of the present invention. FIG. 32A is a back view, FIG. 32B is a front view, FIG. 32C is a left side view, and FIG. 32D is a right side view showing an example of the multilayer ceramic capacitor according to Modification 1-D₂ of the first example embodiment of the present invention. However, the same or corresponding configurations as those in FIGS. 1 to 5B will be denoted by the same reference numerals, and detailed description thereof will be omitted.

The multilayer ceramic capacitor 10D₂ according to Modification 1-D₂ is different from the multilayer ceramic capacitor 10 according to the first example embodiment in the shape of the outer electrode 30. In addition, the outer electrode 30 is not disposed on the second surface 12b.

### Inner Electrode

In the multilayer ceramic capacitor 10D₂ according to Modification 1-D₂, an inner electrode 16 has the same or substantially the same configuration as that of the inner electrode 16 in the multilayer body 12 of the multilayer ceramic capacitor 10D₁ according to Modification 1-D₁ of the first example embodiment of the present invention shown in FIG. 25.

### Outer Electrode

As shown in FIGS. 30 to 32, an outer electrode 30 is disposed on a multilayer body 12.

The outer electrode 30 includes a plurality of outer electrodes 30 connected to a first inner electrode 16d and a second inner electrode 16e. The outer electrode 30 includes a first outer electrode 30a, a second outer electrode 30b, a third outer electrode 30c, and a fourth outer electrode 30d.

The first outer electrode 30a is disposed on the third surface 12c so as to cover a first extended electrode portion 24a of the first inner electrode 16d, and also to partially cover the first surface 12a. The first outer electrode 30a is electrically connected to the first extended electrode portion 24a of the first inner electrode 16d.

The first outer electrode 30a includes a notch portion 40a₁ on the third surface 12c. The notch portion 40a₁ opens toward the fifth surface 12e and the second surface 12b on the third surface 12c.

The second outer electrode 30b is disposed on the sixth surface 12f so as to cover a second extended electrode portion 24b of the second inner electrode 16e, and also to partially cover the first surface 12a. The second outer electrode 30b is electrically connected to the second extended electrode portion 24b of the second inner electrode 16e.

The second outer electrode 30b includes a notch portion 40b₃ on the sixth surface 12f. The notch portion 40b₃ opens toward the third surface 12c and the second surface 12b on the sixth surface 12f.

The third outer electrode 30c is disposed on the fourth surface 12d so as to cover a third extended electrode portion 24c of the first inner electrode 16d, and also to partially cover the first surface 12a. The third outer electrode 30c is electrically connected to the third extended electrode portion 24c of the first inner electrode 16d.

The third outer electrode 30c includes a notch portion 40c₃ on the fourth surface 12d. The notch portion 40c₃ opens toward the sixth surface 12f and the second surface 12b on the fourth surface 12d.

The fourth outer electrode 30d is disposed on the fifth surface 12e so as to cover a fourth extended electrode portion 24d of the second inner electrode 16e, and also to partially cover the first surface 12a. The fourth outer electrode 30d is electrically connected to the fourth extended electrode portion 24d of the second inner electrode 16e.

The fourth outer electrode 30d includes a notch portion 40d₁ on the fifth surface 12e. The notch portion 40d₁ opens toward the fourth surface 12d and the second surface 12b on the fifth surface 12e.

The multilayer ceramic capacitor 10D₂ shown in FIG. 30 has the same or substantially the same advantageous effects as those of the multilayer ceramic capacitor 10 according to the first example embodiment.

### 3. Method for Manufacturing Multilayer Ceramic Capacitor

An example of a method for manufacturing a multilayer ceramic capacitor according to the first example embodiment will be described below.

First, a dielectric sheet and a conductive paste for inner electrodes are prepared. The dielectric sheet and the conductive paste for inner electrodes include a binder and a solvent. Known binders and solvents can be used.

Next, predetermined patterns are printed on the dielectric sheet using the conductive paste for inner electrodes by inkjet printing, screen printing, gravure printing or the like, for example. A dielectric sheet including a first inner electrode pattern formed thereon and a dielectric sheet including a second inner electrode pattern formed thereon are thus prepared. Thereafter, the sheet having the first inner electrode pattern printed thereon and the sheet having the second inner electrode pattern printed thereon are laminated to form a portion to serve as an inner layer portion 18.

When the patterns are printed using each conductive paste, the pattern using the conductive paste for inner electrodes is printed first.

In an example of forming the printing pattern of the inner electrodes by, for example, gravure printing, a gravure plate used in the gravure printing is designed to form a graphic pattern of the first inner electrode and then changed to the structure corresponding to a graphic pattern of the second inner electrode. This makes it possible to form the desired inner electrodes.

Furthermore, in an example of forming the printing pattern of the inner electrodes by screen printing, a screen printing mask is designed to form a graphic pattern of the first inner electrode and then changed to the structure corresponding to a graphic pattern of the second inner electrode. This makes it possible to form the desired inner electrodes.

A predetermined number of dielectric sheets including no inner electrode patterns printed thereon are then laminated to form a portion to define and function as a first outer layer portion 20a on the first surface 12a side. Thereafter, the portion to define and function as the inner layer portion 18 thus prepared is laminated, and the predetermined number of dielectric sheets including no inner electrode patterns printed thereon are laminated on the portion to define and function as the inner layer portion 18 to form a portion to define and function as a second outer layer portion 20b on the second surface 12b side. A multilayer sheet is thus prepared.

Next, the multilayer sheet is pressed in the lamination direction by, for example, an isostatic press or the like to produce a multilayer block.

Then, the multilayer block is cut to a predetermined size, thus cutting out a multilayer chip. In this event, the corners and ridges of the multilayer chip may be rounded by barrel polishing or the like, for example.

Next, the multilayer chip is fired to produce a multilayer body 12. The firing temperature depends on the ceramic and inner electrode materials, but is, for example, preferably about 900° C. to about 1400° C.

Thereafter, an outer electrode 30 is formed in the multilayer body 12.

The multilayer body 12 including an underlying plating layer 32 formed thereon is placed on a work table, and a thin film layer 34 is formed on the first surface 12a by sputtering, for example.

Then, a surface plating layer 36 is formed on the underlying plating layer 32 and the thin film layer 34 disposed on the surface of the multilayer body 12. More specifically, for example, a Ni plating layer and a Sn plating layer are formed as the surface plating layer 36 on the underlying plating layer 32 and the thin film layer 34. Either electrolytic plating or electroless plating may be used for the plating process. However, electroless plating requires pretreatment with a catalyst or the like to improve the plating deposition speed, resulting in a disadvantage of complicating the process. Therefore, it is usually preferable to use electrolytic plating.

The multilayer ceramic capacitor 10 according to the example embodiment illustrated in FIG. 1 can thus be manufactured.

### B. Second Example Embodiment

### 1. Multilayer Ceramic Capacitor

An example of a multilayer ceramic capacitor 110 according to a second example embodiment of the present invention will be described.

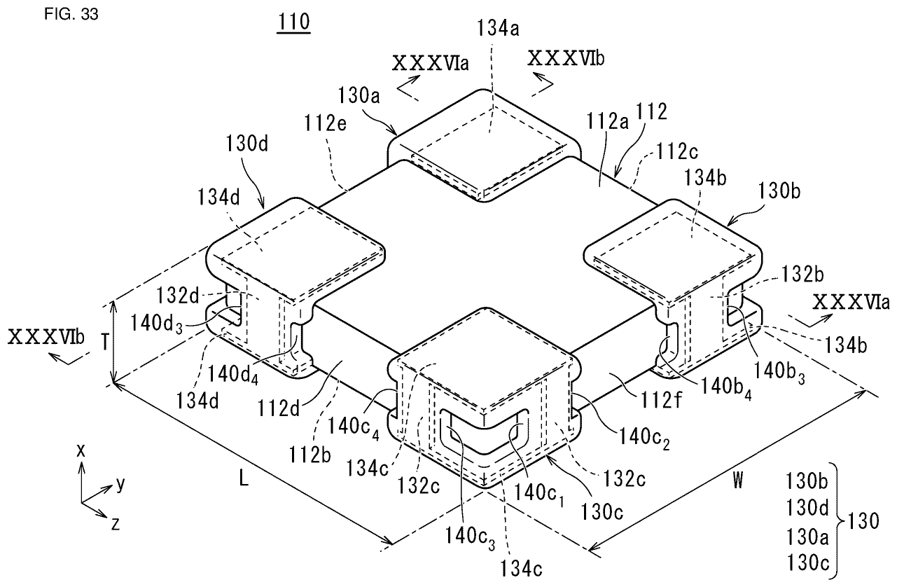

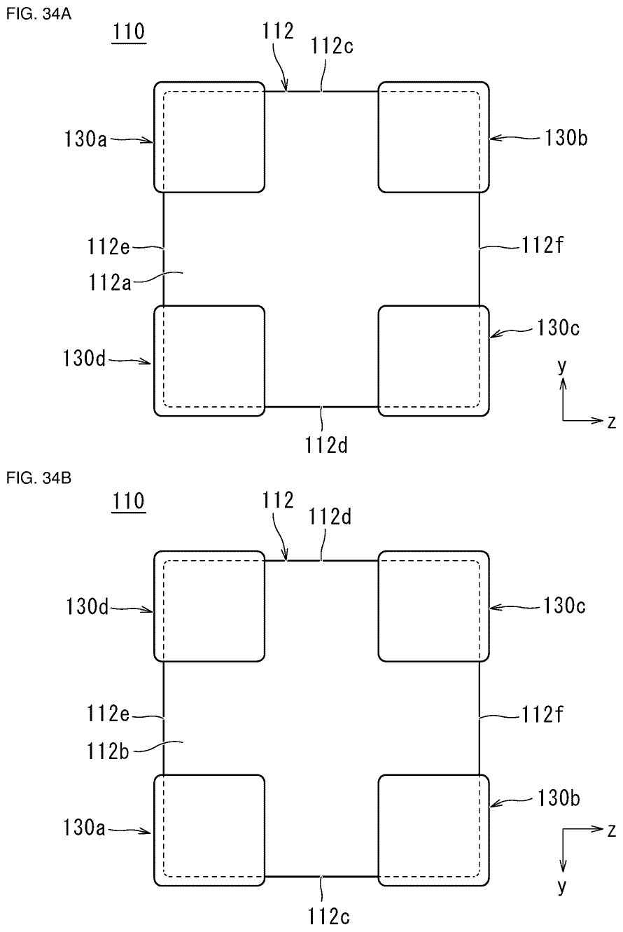

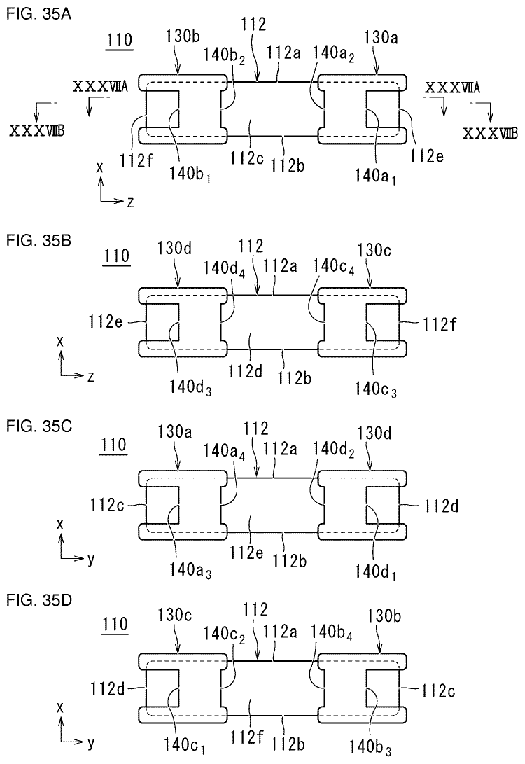

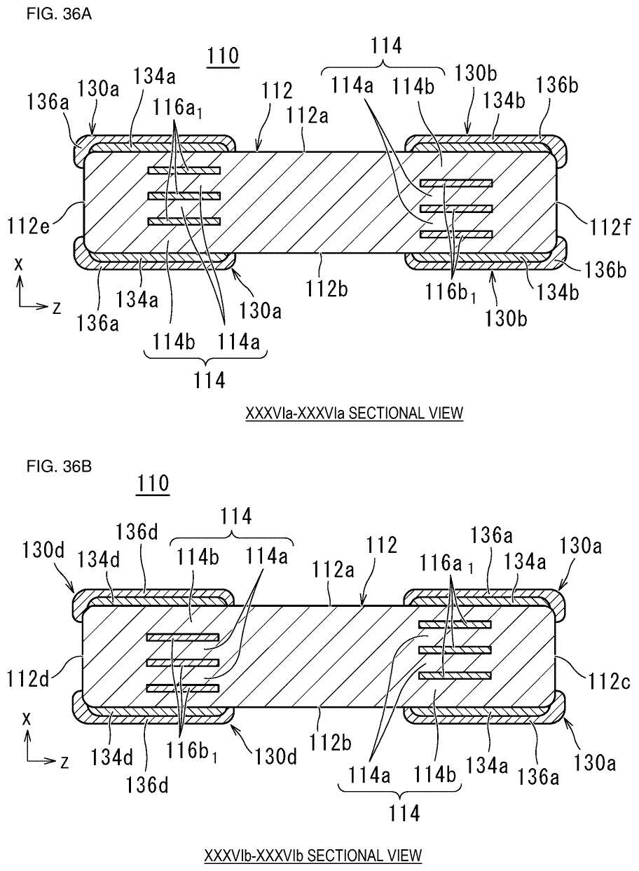

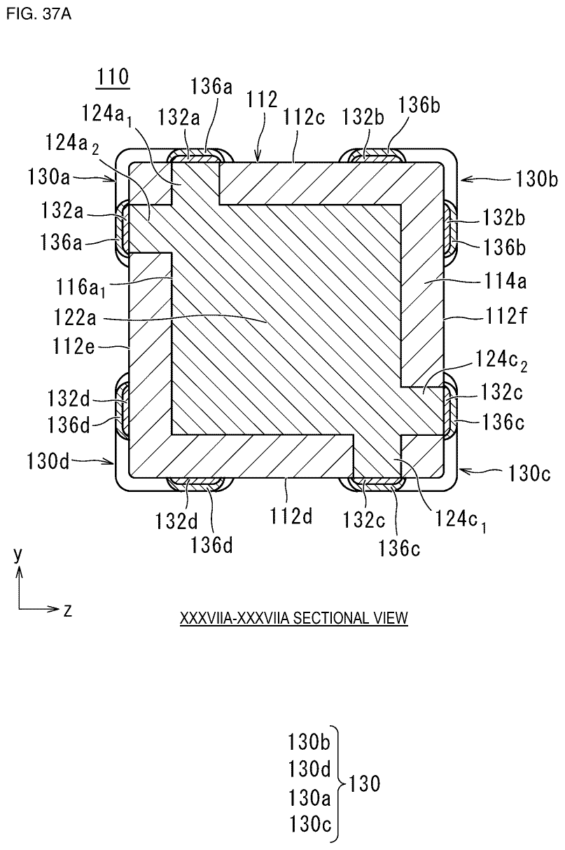

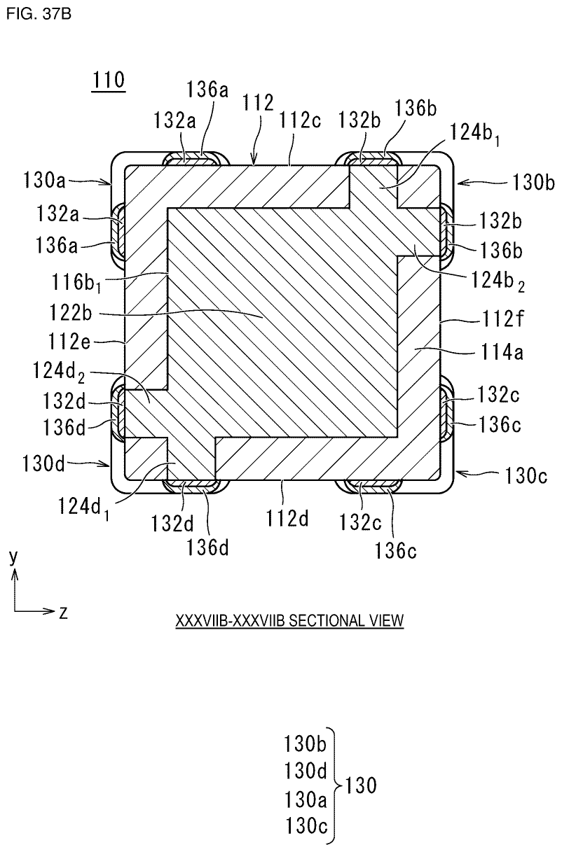

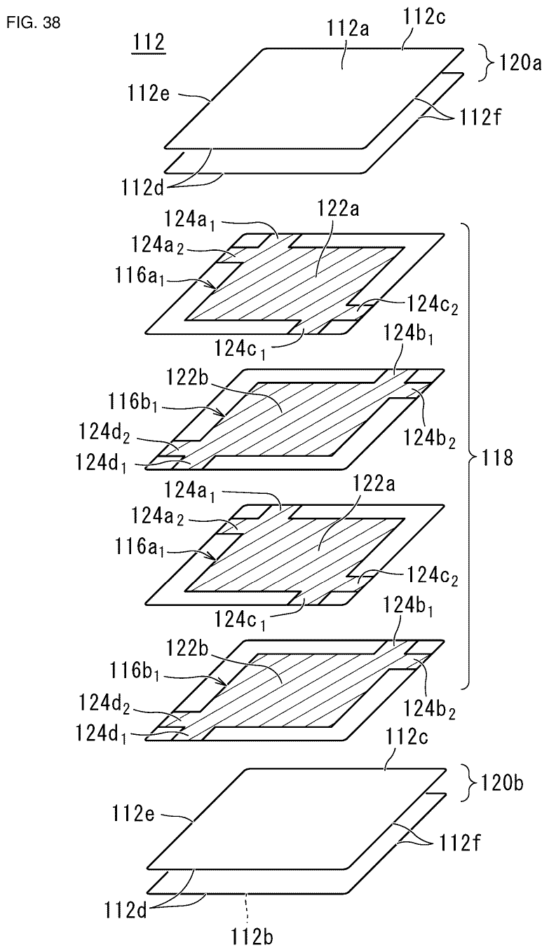

FIG. 33 is an external perspective view from one side showing an example of the multilayer ceramic capacitor according to the second example embodiment of the present invention. FIG. 34A is a plan view and FIG. 34B is a bottom view showing an example of the multilayer ceramic capacitor according to the second example embodiment of the present invention. FIG. 35A is a back view, FIG. 35B is a front view, FIG. 35C is a left side view, and FIG. 35D is a right side view showing an example of the multilayer ceramic capacitor according to the second example embodiment of the present invention. FIG. 36A is a schematic sectional view taken along line XXXVIa-XXXVIa in FIG. 33 and FIG. 36B is a schematic sectional view taken along line XXXVIb-XXXVIb in FIG. 33. FIG. 37A is a schematic sectional view taken along line XXXVIIA-XXXVIIA in FIG. 35A. FIG. 37B is a schematic sectional view taken along line XXXVIIB-XXXVIIB in FIG. 35A. FIG. 38 is an exploded perspective view of a multilayer body shown in FIG. 33.

The multilayer ceramic capacitor 110 includes a multilayer body 112 and a plurality of outer electrodes 130.

### Multilayer Body

In the multilayer ceramic capacitor 110 according to the second example embodiment, the multilayer body 112 has the same or substantially the same configuration as that of the multilayer body 12 according to the first example embodiment of the present invention shown in FIG. 1.

### Inner Electrode

A first inner electrode 116a₁ is extended to a third surface 112c of the multilayer body 112 by a first extended electrode portion 124a₁, and is extended to a fifth surface 112e of the multilayer body 112 by a first extended electrode portion 124a₂.

The first inner electrode 116a₁ is also extended to a fourth surface 112d of the multilayer body 112 by a third extended electrode portion 124c₁, and is extended to a sixth surface 112f of the multilayer body 112 by a third extended electrode portion 124c₂.

A second inner electrode 116b₁ is extended to the third surface 112c of the multilayer body 112 by a second extended electrode portion 124b₁, and is extended to the sixth surface 112f of the multilayer body 112 by a second extended electrode portion 124b₂.

The second inner electrode 116b₁ is also extended to the fourth surface 112d of the multilayer body 112 by a fourth extended electrode portion 124d₁, and is extended to the fifth surface 112e of the multilayer body 112 by a fourth extended electrode portion 124d₂.

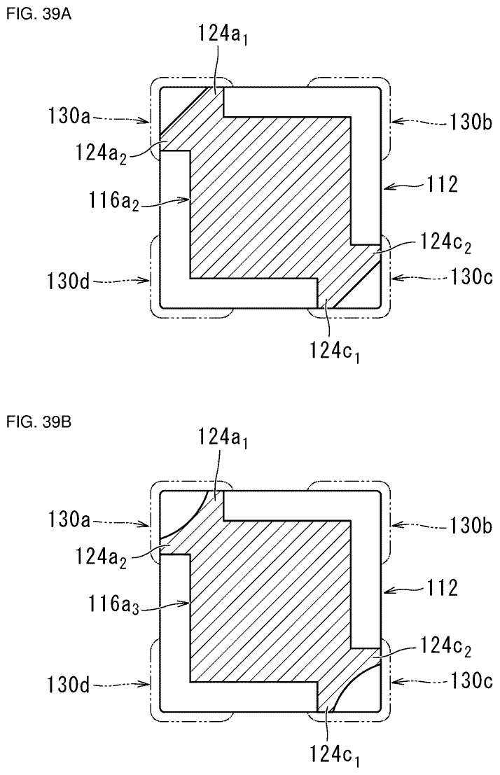

Here, modifications of the shape of the inner electrode 116 will be described. FIGS. 39A and 39B show first inner electrodes 116a₂ and 116a₃ as modifications of the first inner electrode 116a₁. For the multilayer ceramic capacitor 110 according to example embodiments of the present invention, the first inner electrodes 116a₂ and 116a₃ can be used.

In the first inner electrode 116a₁, the shape surrounded by the first extended electrode portion 124a₁, the first extended electrode portion 124a₂, the third surface 112c, and the fifth surface 112e is rectangular or substantially rectangular in plan view.

In the first inner electrode 116a₂, on the other hand, the shape surrounded by the first extended electrode portion 124a₁, the first extended electrode portion 124a₂, the third surface 112c, and the fifth surface 112e is triangular or substantially triangular in plan view.

In the first inner electrode 116a₃, the shape surrounded by the first extended electrode portion 124a₁, the first extended electrode portion 124a₂, the third surface 112c, and the fifth surface 112e is a fan shape centered on a corner of the multilayer body 112 in plan view.

### Outer Electrode

As illustrated in FIGS. 33 to 36, an outer electrode 130 is disposed on the multilayer body 112.

The outer electrode 130 includes a plurality of outer electrodes 130 connected to the first inner electrode 116a₁ and the second inner electrode 116b₁. The outer electrode 130 includes a first outer electrode 130a, a second outer electrode 130b, a third outer electrode 130c, and a fourth outer electrode 130d.

The first outer electrode 130a is disposed so as to cover the first extended electrode portion 124a₁ of the first inner electrode 116a₁ on the third surface 112c, and also to cover the first extended electrode portion 124a₂ of the first inner electrode 116a₁ on the fifth surface 112e. The first outer electrode 130a is also disposed so as to partially cover the first surface 112a and the second surface 112b. The first outer electrode 130a is electrically connected to the first extended electrode portions 124a₁ and 124a₂ of the first inner electrode 116a₁.

The first outer electrode 130a includes a notch portion 140a₁ and a notch portion 140a₂ on the third surface 112c. The notch portion 140a₁ opens toward the fifth surface 112e on the third surface 112c. The notch portion 140a₂ opens toward the sixth surface 112f on the third surface 112c.

The first outer electrode 130a also includes a notch portion 140a₃ and a notch portion 140a₄ on the fifth surface 112e. The notch portion 140a₃ opens toward the third surface 112c on the fifth surface 112e. The notch portion 140a₄ opens toward the fourth surface 112d on the fifth surface 112e.

The second outer electrode 130b is disposed so as to cover the second extended electrode portion 124b₁ of the second inner electrode 116b₁ on the third surface 112c, and also to cover the second extended electrode portion 124b₂ of the second inner electrode 116b₁ on the sixth surface 112f. The second outer electrode 130b is also disposed so as to partially cover the first surface 112a and the second surface 112b. The second outer electrode 130b is electrically connected to the second extended electrode portions 124b₁ and 124b₂ of the second inner electrode 116b₁.

The second outer electrode 130b includes a notch portion 140b₁ and a notch portion 140b₂ on the third surface 112c. The notch portion 140b₁ opens toward the sixth surface 112f on the third surface 112c. The notch portion 140b₂ opens toward the fifth surface 112e on the third surface 112c.

The second outer electrode 130b also includes a notch portion 140b₃ and a notch portion 140b₄ on the sixth surface 112f. The notch portion 140b₃ opens toward the third surface 112c on the sixth surface 112f. The notch portion 140b₄ opens toward the fourth surface 112d on the sixth surface 112f.

The third outer electrode 130c is disposed so as to cover the third extended electrode portion 124c₁ of the first inner electrode 116a₁ on the fourth surface 112d, and also to cover the third extended electrode portion 124c₂ of the first inner electrode 116a₁ on the sixth surface 112f. The third outer electrode 130c is also disposed so as to partially cover the first surface 112a and the second surface 112b. The third outer electrode 130c is electrically connected to the third extended electrode portions 124c₁ and 124c₂ of the first inner electrode 116a₁.

The third outer electrode 130c includes a notch portion 140c₁ and a notch portion 140c₂ on the sixth surface 112f. The notch portion 140ci opens toward the fourth surface 112d on the sixth surface 112f. The notch portion 140c₂ opens toward the third surface 112c on the sixth surface 112f.

The third outer electrode 130c also includes a notch portion 140c₃ and a notch portion 140c₄ on the fourth surface 112d. The notch portion 140c₃ opens toward the sixth surface 112f on the fourth surface 112d. The notch portion 140c₄ opens toward the fifth surface 112e on the fourth surface 112d.

The fourth outer electrode 130d is disposed so as to cover the fourth extended electrode portion 124d₁ of the second inner electrode 116b₁ on the fourth surface 112d, and also to cover the fourth extended electrode portion 124d₂ of the second inner electrode 116b₁ on the fifth surface 112e. The fourth outer electrode 130d is also disposed so as to partially cover the first surface 112a and the second surface 112b. The fourth outer electrode 130d is electrically connected to the fourth extended electrode portions 124d₁ and 124d₂ of the second inner electrode 116b₁.

The fourth outer electrode 130d includes a notch portion 140d₁ and a notch portion 140d₂ on the fifth surface 112e. The notch portion 140d₁ opens toward the fourth surface 112d on the fifth surface 112e. The notch portion 140d₂ opens toward the third surface 112c on the fifth surface 112e.

The fourth outer electrode 130d also includes a notch portion 140d₃ and a notch portion 140d₄ on the fourth surface 112d. The notch portion 140d₃ opens toward the fifth surface 112e on the fourth surface 112d. The notch portion 140d₄ opens toward the sixth surface 112f on the fourth surface 112d.

In the multilayer body 112, the first counter electrode portion 122a of the first inner electrode 116a₁ and the second counter electrode portion 122b of the second inner electrode 116b₁ face each other across the inner dielectric layer 114a, thus generating an electrostatic capacitance. Therefore, the electrostatic capacitance can be obtained between the first outer electrode 130a and the third outer electrode 130c, to which the first inner electrode 116a₁ is connected, and the second outer electrode 130b and the fourth outer electrode 130d, to which the second inner electrode 116b₁ is connected, thus providing the capacitor characteristics.

The multilayer ceramic capacitor 110 according to the second example embodiment shown in FIG. 33 has the same or substantially the same advantageous effects as those of the multilayer ceramic capacitor 10 described above.

The multilayer ceramic capacitor 110 according to the second example embodiment of the present invention may also be combined with all or some of the above modifications.

### 2. Modification

### (1) Modification 2-A

Next, an example of a multilayer ceramic capacitor 110A according to Modification 2-A of the second example embodiment of the present invention will be described.

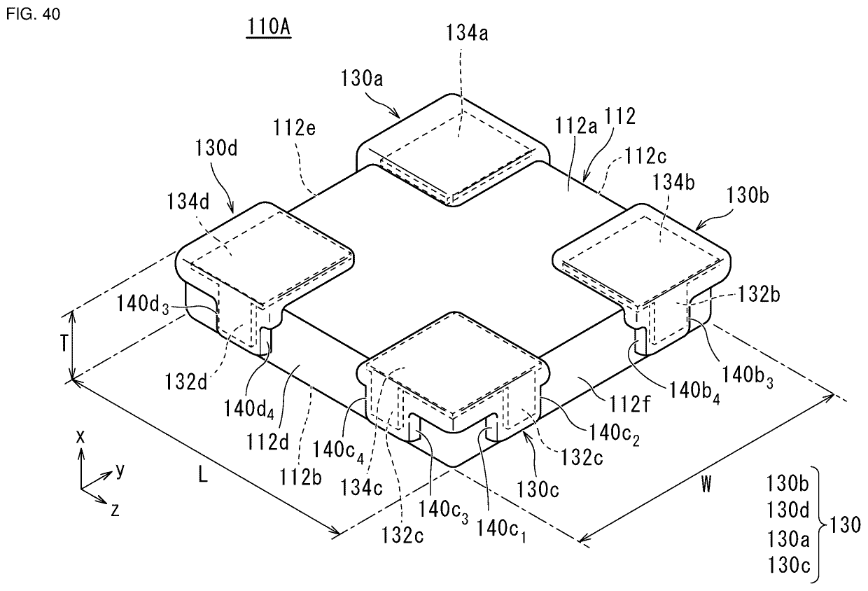

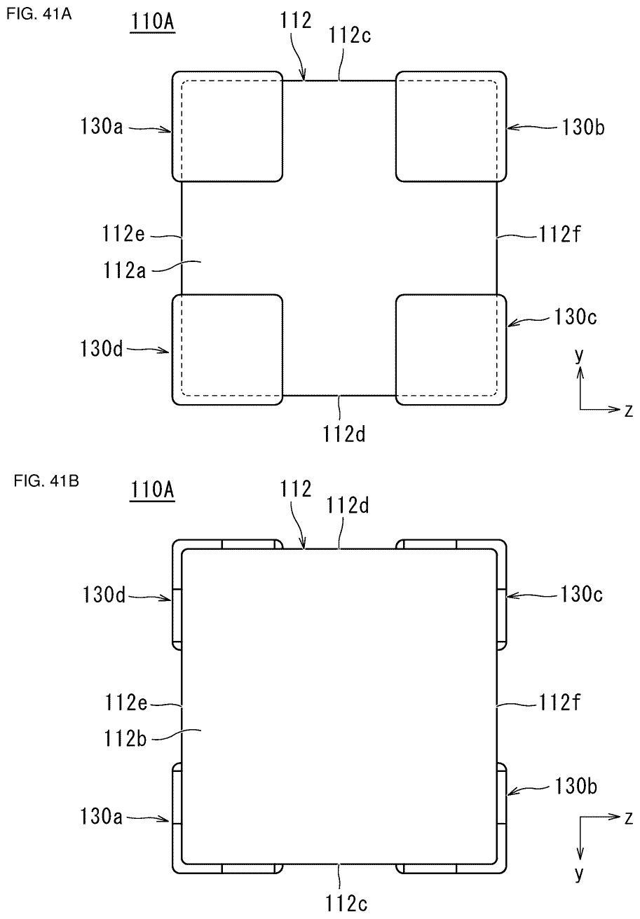

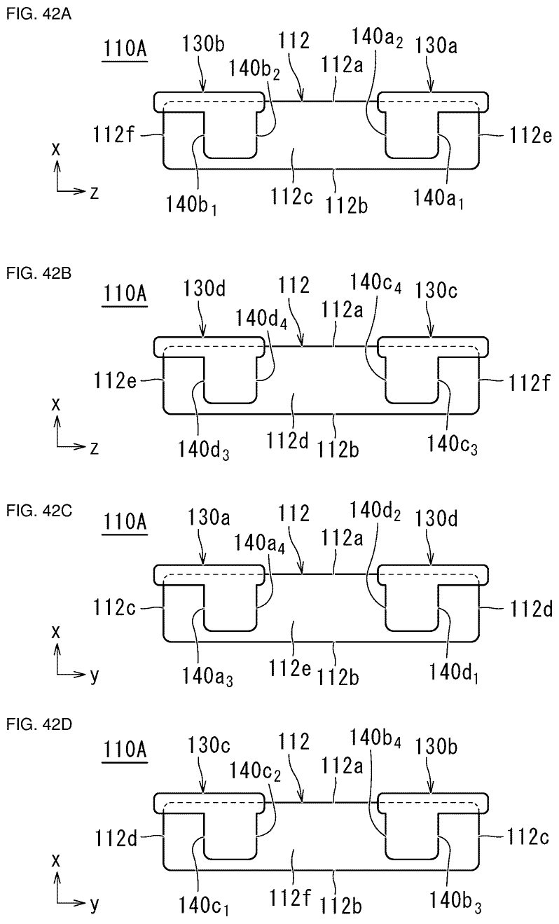

FIG. 40 is an external perspective view showing an example of the multilayer ceramic capacitor according to Modification 2-A of the second example embodiment of the present invention. FIG. 41A is a plan view and FIG. 41B is a bottom view showing an example of the multilayer ceramic capacitor according to Modification 2-A of the second example embodiment of the present invention. FIG. 42A is a back view, FIG. 42B is a front view, FIG. 42C is a left side view, and FIG. 42D is a right side view showing an example of the multilayer ceramic capacitor according to Modification 2-A of the second example embodiment of the present invention. However, the same or corresponding configurations as those in FIGS. 33 to 37B will be denoted by the same reference numerals, and detailed description thereof will be omitted. The multilayer ceramic capacitor 110A according to Modification 2-A is different from the multilayer ceramic capacitor 110 according to the second example embodiment in the shape of the outer electrode 130. In addition, the outer electrode 130 is not disposed on the second surface 112b.

### Inner Electrode

In the multilayer ceramic capacitor 110A according to Modification 2-A, an inner electrode 116 has the same or substantially the same configuration as that of the inner electrode 116 in the multilayer body 112 of the multilayer ceramic capacitor 110 according to the second example embodiment of the present invention shown in FIG. 33.

### Outer Electrode

As shown in FIGS. 40 to 42, an outer electrode 130 is disposed on a multilayer body 112.

The outer electrode 130 includes a plurality of outer electrodes 130 connected to a first inner electrode 116a₁ and a second inner electrode 116b₁. The outer electrode 130 includes a first outer electrode 130a, a second outer electrode 130b, a third outer electrode 130c, and a fourth outer electrode 130d.

The first outer electrode 130a is disposed so as to cover the first extended electrode portion 124a₁ of the first inner electrode 116a₁ on the third surface 112c, and also to cover the first extended electrode portion 124a₂ of the first inner electrode 116a₁ on the fifth surface 112e. The first outer electrode 130a is also disposed so as to partially cover the first surface 112a. The first outer electrode 130a is electrically connected to the first extended electrode portions 124a₁ and 124a₂ of the first inner electrode 116a₁.

The first outer electrode 130a includes a notch portion 140a₁ and a notch portion 140a₂ on the third surface 112c. The notch portion 140a₁ opens toward the fifth surface 112e and the second surface 112b on the third surface 112c. The notch portion 140a₂ opens toward the sixth surface 112f and the second surface 112b on the third surface 112c.

The first outer electrode 130a also includes a notch portion 140a₃ and a notch portion 140a₄ on the fifth surface 112e. The notch portion 140a₃ opens toward the third surface 112c and the second surface 112b on the fifth surface 112e. The notch portion 140a₄ opens toward the fourth surface 112d and the second surface 112b on the fifth surface 112e.

The second outer electrode 130b is disposed so as to cover the second extended electrode portion 124b₁ of the second inner electrode 116b₁ on the third surface 112c, and also to cover the second extended electrode portion 124b₂ of the second inner electrode 116b₁ on the sixth surface 112f. The second outer electrode 130b is also disposed so as to partially cover the first surface 112a. The second outer electrode 130b is electrically connected to the second extended electrode portions 124b₁ and 124b₂ of the second inner electrode 116b₁.

The second outer electrode 130b includes a notch portion 140b₁ and a notch portion 140b₂ on the third surface 112c. The notch portion 140b₁ opens toward the sixth surface 112f and the second surface 112b on the third surface 112c. The notch portion 140b₂ opens toward the fifth surface 112e and the second surface 112b on the third surface 112c.

The second outer electrode 130b also includes a notch portion 140b₃ and a notch portion 140b₄ on the sixth surface 112f. The notch portion 140b₃ opens toward the third surface 112c and the second surface 112b on the sixth surface 112f. The notch portion 140b₄ opens toward the fourth surface 112d and the second surface 112b on the sixth surface 112f.

The third outer electrode 130c is disposed so as to cover the third extended electrode portion 124c₁ of the first inner electrode 116a₁ on the fourth surface 112d, and also to cover the third extended electrode portion 124c₂ of the first inner electrode 116a₁ on the sixth surface 112f. The third outer electrode 130c is also disposed so as to partially cover the first surface 112a. The third outer electrode 130c is electrically connected to the third extended electrode portions 124c₁ and 124c₂ of the first inner electrode 116a₁.

The third outer electrode 130c includes a notch portion 140c₁ and a notch portion 140c₂ on the sixth surface 112f. The notch portion 140c₁ opens toward the fourth surface 112d and the second surface 112b on the sixth surface 112f. The notch portion 140c₂ opens toward the third surface 112c and the second surface 112b on the sixth surface 112f.

The third outer electrode 130c also includes a notch portion 140c₃ and a notch portion 140c₄ on the fourth surface 112d. The notch portion 140c₃ opens toward the sixth surface 112f and the second surface 112b on the fourth surface 112d. The notch portion 140c₄ opens toward the fifth surface 112e and the second surface 112b on the fourth surface 112d.

The fourth outer electrode 130d is disposed so as to cover the fourth extended electrode portion 124d₁ of the second inner electrode 116b₁ on the fourth surface 112d, and also to cover the fourth extended electrode portion 124d₂ of the second inner electrode 116b₁ on the fifth surface 112e. The fourth outer electrode 130d is also disposed so as to partially cover the first surface 112a. The fourth outer electrode 130d is electrically connected to the fourth extended electrode portions 124d₁ and 124d₂ of the second inner electrode 116b₁.

The fourth outer electrode 130d includes a notch portion 140d₁ and a notch portion 140d₂ on the fifth surface 112e. The notch portion 140d₁ opens toward the fourth surface 112d and the second surface 112b on the fifth surface 112e. The notch portion 140d₂ opens toward the third surface 112c and the second surface 112b on the fifth surface 112e.

The fourth outer electrode 130d also includes a notch portion 140d₃ and a notch portion 140d₄ on the fourth surface 112d. The notch portion 140d₃ opens toward the fifth surface 112e and the second surface 112b on the fourth surface 112d. The notch portion 140d₄ opens toward the sixth surface 112f and the second surface 112b on the fourth surface 112d.

The multilayer ceramic capacitor 110A shown in FIG. 40 has the same or substantially the same advantageous effects as those of the multilayer ceramic capacitor 10 according to the first example embodiment.

### (2) Modification 2-B₁

Next, an example of a multilayer ceramic capacitor 110B₁ according to Modification 2-B₁ of the second example embodiment of the present invention will be described.

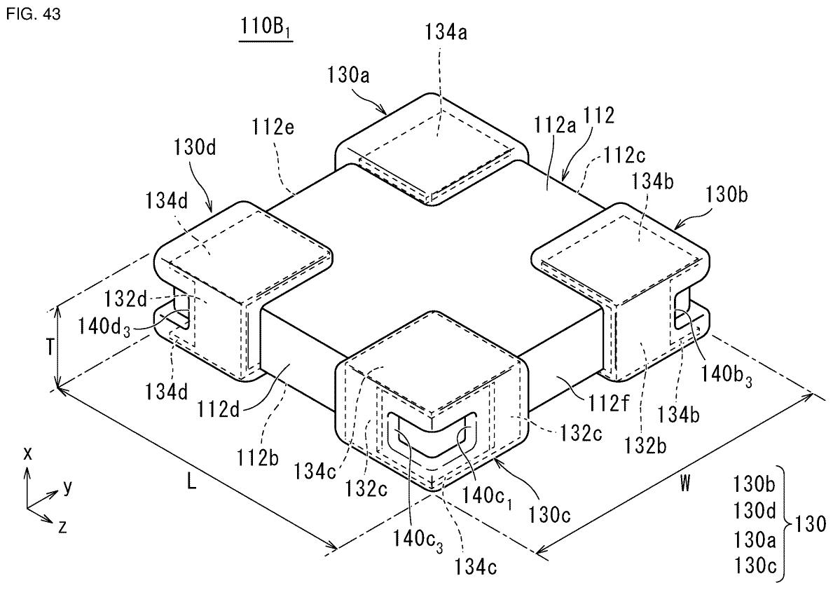

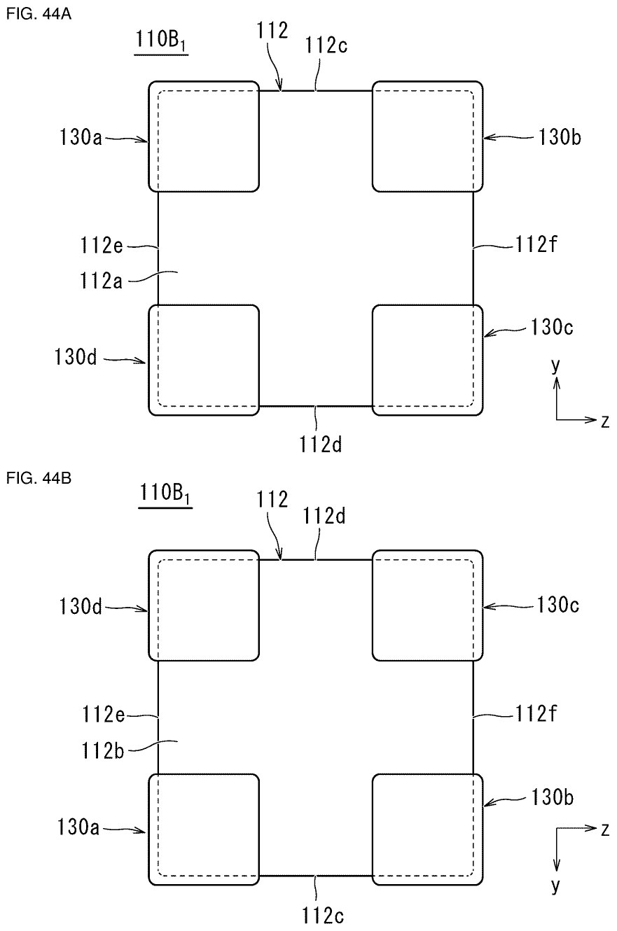

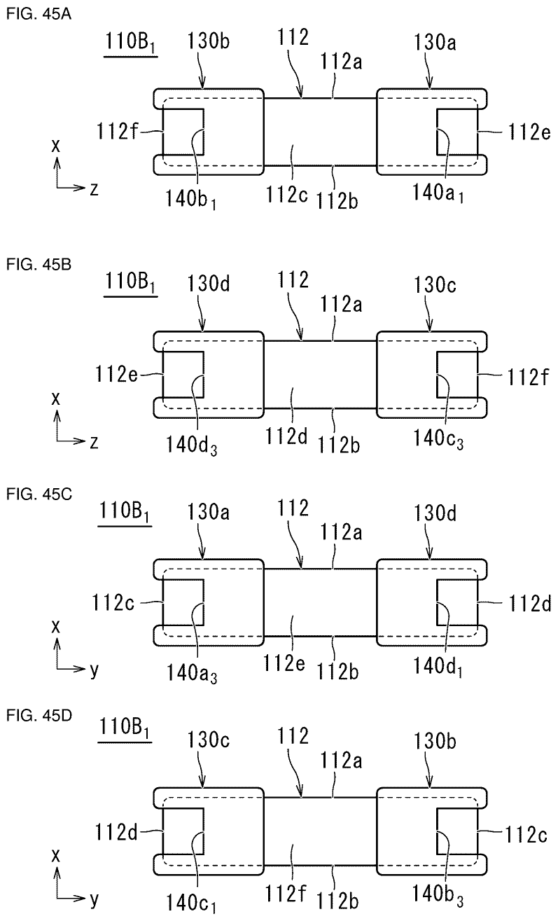

FIG. 43 is an external perspective view showing an example of the multilayer ceramic capacitor according to Modification 2-B₁ of the second example embodiment of the present invention. FIG. 44A is a plan view and FIG. 44B is a bottom view showing an example of the multilayer ceramic capacitor according to Modification 2-B₁ of the second example embodiment of the present invention. FIG. 45A is a back view, FIG. 45B is a front view, FIG. 45C is a left side view, and FIG. 45D is a right side view showing an example of the multilayer ceramic capacitor according to Modification 2-B₁ of the second example embodiment of the present invention. However, the same or corresponding configurations as those in FIGS. 33 to 37B will be denoted by the same reference numerals, and detailed description thereof will be omitted.

The multilayer ceramic capacitor 110B₁ according to Modification 2-B₁ from is different the multilayer ceramic capacitor 110 according to the second example embodiment in the shape of the outer electrode 130.

### Inner Electrode

In the multilayer ceramic capacitor 110B₁ according to Modification 2-B₁, an inner electrode 116 has the same or substantially the same configuration as that of the inner electrode 116 in the multilayer body 112 of the multilayer ceramic capacitor 110 according to the second example embodiment of the present invention shown in FIG. 33.

### Outer Electrode

As shown in FIGS. 43 to 45, an outer electrode 130 is disposed on a multilayer body 112.

The outer electrode 130 includes a plurality of outer electrodes 130 connected to a first inner electrode 116a₁ and a second inner electrode 116b₁. The outer electrode 130 includes a first outer electrode 130a, a second outer electrode 130b, a third outer electrode 130c, and a fourth outer electrode 130d.

The first outer electrode 130a is disposed so as to cover the first extended electrode portion 124a₁ of the first inner electrode 116a₁ on the third surface 112c, and also to cover the first extended electrode portion 124a₂ of the first inner electrode 116a₁ on the fifth surface 112e. The first outer electrode 130a is also disposed so as to partially cover the first surface 112a and the second surface 112b. The first outer electrode 130a is electrically connected to the first extended electrode portions 124a₁ and 124a₂ of the first inner electrode 116a₁.

The first outer electrode 130a includes a notch portion 140a₁ on the third surface 112c. The notch portion 140a₁ opens toward the fifth surface 112e on the third surface 112c.

The first outer electrode 130a also includes a notch portion 140a₃ on the fifth surface 112e. The notch portion 140a₃ opens toward the third surface 112c on the fifth surface 112e.

The second outer electrode 130b is disposed so as to cover the second extended electrode portion 124b₁ of the second inner electrode 116b₁ on the third surface 112c, and also to cover the second extended electrode portion 124b₂ of the second inner electrode 116b₁ on the sixth surface 112f. The second outer electrode 130b is also disposed so as to partially cover the first surface 112a and the second surface 112b. The second outer electrode 130b is electrically connected to the second extended electrode portions 124b₁ and 124b₂ of the second inner electrode 116b₁.

The second outer electrode 130b includes a notch portion 140b₁ on the third surface 112c. The notch portion 140b₁ opens toward the sixth surface 112f on the third surface 112c.

The second outer electrode 130b also includes a notch portion 140b₃ on the sixth surface 112f. The notch portion 140b₃ opens toward the third surface 112c on the sixth surface 112f.

The third outer electrode 130c is disposed so as to cover the third extended electrode portion 124c₁ of the first inner electrode 116a₁ on the fourth surface 112d, and also to cover the third extended electrode portion 124c₂ of the first inner electrode 116a₁ on the sixth surface 112f. The third outer electrode 130c is also disposed so as to partially cover the first surface 112a and the second surface 112b. The third outer electrode 130c is electrically connected to the third extended electrode portions 124c₁ and 124c₂ of the first inner electrode 116a₁.

The third outer electrode 130c includes a notch portion 140c₁ on the sixth surface 112f. The notch portion 140c₁ opens toward the fourth surface 112d on the sixth surface 112f.

The third outer electrode 130c also includes a notch portion 140c₃ on the fourth surface 112d. The notch portion 140c₃ opens toward the sixth surface 112f on the fourth surface 112d.

The fourth outer electrode 130d is disposed so as to cover the fourth extended electrode portion 124d₁ of the second inner electrode 116b₁ on the fourth surface 112d, and also to cover the fourth extended electrode portion 124d₂ of the second inner electrode 116b₁ on the fifth surface 112e. The fourth outer electrode 130d is also disposed so as to partially cover the first surface 112a and the second surface 112b. The fourth outer electrode 130d is electrically connected to the fourth extended electrode portions 124d₁ and 124d₂ of the second inner electrode 116b₁.

The fourth outer electrode 130d includes a notch portion 140d₁ on the fifth surface 112e. The notch portion 140d₁ opens toward the fourth surface 112d on the fifth surface 112e.

The fourth outer electrode 130d also includes a notch portion 140d₃ on the fourth surface 112d. The notch portion 140d₃ opens toward the fifth surface 112e on the fourth surface 112d.

The multilayer ceramic capacitor 110B₁ shown in FIG. 43 has the same or substantially the same advantageous effects as those of the multilayer ceramic capacitor 10 according to the first example embodiment.

### (2) Modification 2-B₂

Next, an example of a multilayer ceramic capacitor 110B₂ according to Modification 2-B₂ of the second example embodiment of the present invention will be described.

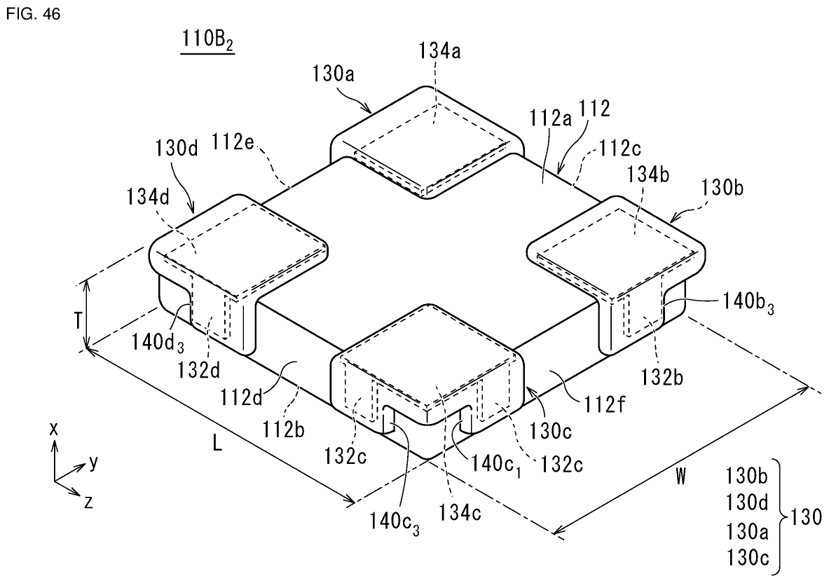

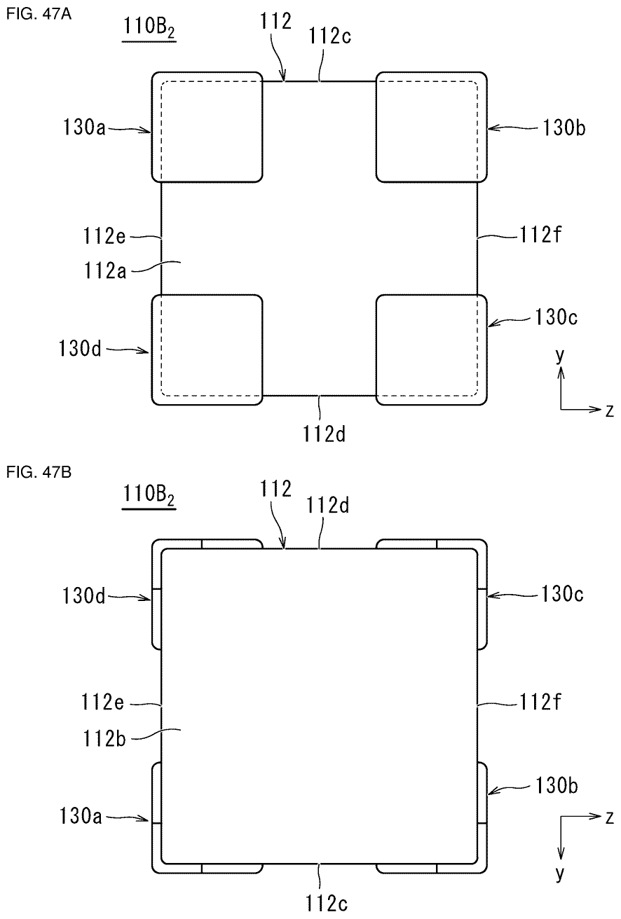

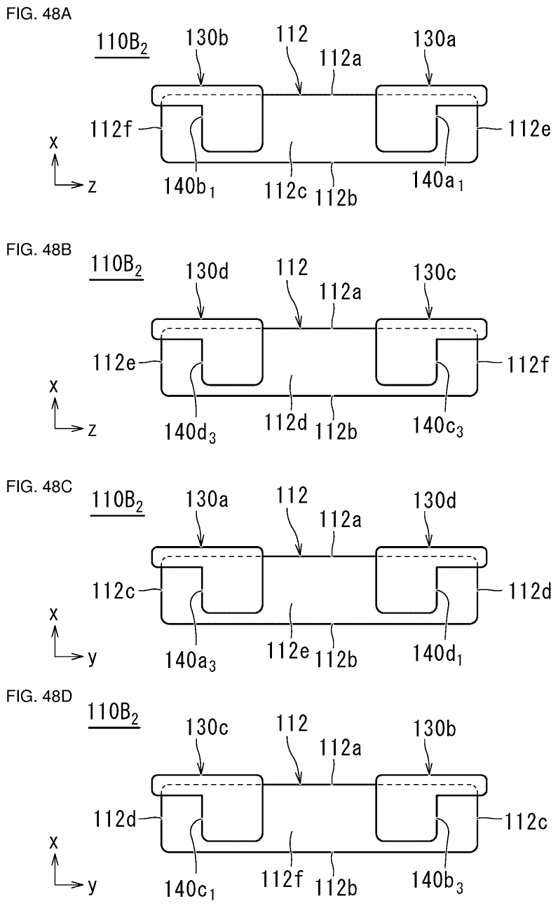

FIG. 46 is an external perspective view showing an example of the multilayer ceramic capacitor according to Modification 2-B₂ of the second example embodiment of the present invention. FIG. 47A is a plan view and FIG. 47B is a bottom view showing an example of the multilayer ceramic capacitor according to Modification 2-B₂ of the second example embodiment of the present invention. FIG. 48A is a back view, FIG. 48B is a front view, FIG. 48C is a left side view, and FIG. 48D is a right side view showing an example of the multilayer ceramic capacitor according to Modification 2-B₂ of the second example embodiment of the present invention. However, the same or corresponding configurations as those in FIGS. 33 to 37B will be denoted by the same reference numerals, and detailed description thereof will be omitted.

The multilayer ceramic capacitor 110B₂ according to Modification 2-B₂ is: from the multilayer ceramic capacitor 110 according to the second example embodiment in the shape of the outer electrode 130. In addition, the outer electrode 130 is not disposed on the second surface 112b.

### Inner Electrode

In the multilayer ceramic capacitor 110B₂ according to Modification 2-B₂, an inner electrode 116 has the same or substantially the same configuration as that of the inner electrode 116 in the multilayer body 112 of the multilayer ceramic capacitor 110 according to the second example embodiment of the present invention shown in FIG. 33.

### Outer Electrode

As shown in FIGS. 46 to 48, an outer electrode 130 is disposed on a multilayer body 112.

The outer electrode 130 includes a plurality of outer electrodes 130 connected to a first inner electrode 116a₁ and a second inner electrode 116b₁. The outer electrode 130 includes a first outer electrode 130a, a second outer electrode 130b, a third outer electrode 130c, and a fourth outer electrode 130d.

The first outer electrode 130a is disposed so as to cover the first extended electrode portion 124a₁ of the first inner electrode 116a₁ on the third surface 112c, and also to cover the first extended electrode portion 124a₂ of the first inner electrode 116a₁ on the fifth surface 112e. The first outer electrode 130a is also disposed so as to partially cover the first surface 112a. The first outer electrode 130a is electrically connected to the first extended electrode portions 124a₁ and 124a₂ of the first inner electrode 116a₁.

The first outer electrode 130a includes a notch portion 140a₁ on the third surface 112c. The notch portion 140a₁ opens toward the fifth surface 112e and the second surface 112b on the third surface 112c.

The first outer electrode 130a also includes a notch portion 140a₃ on the fifth surface 112e. The notch portion 140a₃ opens toward the third surface 112c and the second surface 112b on the fifth surface 112e.

The second outer electrode 130b is disposed so as to cover the second extended electrode portion 124b₁ of the second inner electrode 116b₁ on the third surface 112c, and also to cover the second extended electrode portion 124b₂ of the second inner electrode 116b₁ on the sixth surface 112f. The second outer electrode 130b is also disposed so as to partially cover the first surface 112a. The second outer electrode 130b is electrically connected to the second extended electrode portions 124b₁ and 124b₂ of the second inner electrode 116b₁.

The second outer electrode 130b includes a notch portion 140b₁ on the third surface 112c. The notch portion 140b₁ opens toward the sixth surface 112f and the second surface 112b on the third surface 112c.

The second outer electrode 130b also includes a notch portion 140b₃ on the sixth surface 112f. The notch portion 140b₃ opens toward the third surface 112c and the second surface 112b on the sixth surface 112f.

The third outer electrode 130c is disposed so as to cover the third extended electrode portion 124c₁ of the first inner electrode 116a₁ on the fourth surface 112d, and also to cover the third extended electrode portion 124c₂ of the first inner electrode 116a₁ on the sixth surface 112f. The third outer electrode 130c is also disposed so as to partially cover the first surface 112a. The third outer electrode 130c is electrically connected to the third extended electrode portions 124c₁ and 124c₂ of the first inner electrode 116a₁.

The third outer electrode 130c includes a notch portion 140c₁ on the sixth surface 112f. The notch portion 140ci opens toward the fourth surface 112d and the second surface 112b on the sixth surface 112f.

The third outer electrode 130c also includes a notch portion 140c₃ on the fourth surface 112d. The notch portion 140c₃ opens toward the sixth surface 112f and the second surface 112b on the fourth surface 112d.

The fourth outer electrode 130d is disposed so as to cover the fourth extended electrode portion 124d₁ of the second inner electrode 116b₁ on the fourth surface 112d, and also to cover the fourth extended electrode portion 124d₂ of the second inner electrode 116b₁ on the fifth surface 112e. The fourth outer electrode 130d is also disposed so as to partially cover the first surface 112a. The fourth outer electrode 130d is electrically connected to the fourth extended electrode portions 124d₁ and 124d₂ of the second inner electrode 116b₁.

The fourth outer electrode 130d includes a notch portion 140d₁ on the fifth surface 112e. The notch portion 140d₁ opens toward the fourth surface 112d and the second surface 112b on the fifth surface 112e.

The fourth outer electrode 130d also includes a notch portion 140d₃ on the fourth surface 112d. The notch portion 140d₃ opens toward the fifth surface 112e and the second surface 112b on the fourth surface 112d.

The multilayer ceramic capacitor 110B₂ shown in FIG. 46 has the same or substantially the same advantageous effects as those of the multilayer ceramic capacitor 10 according to the first example embodiment.

### 3. Method for Manufacturing Multilayer Ceramic Capacitor

An example of a method for manufacturing a multilayer ceramic capacitor according to the second example embodiment will be described below.

First, a dielectric sheet and a conductive paste for inner electrodes are prepared. The dielectric sheet and the conductive paste for inner electrodes include a binder and a solvent. Known binders and solvents can be used.

Next, predetermined patterns are printed on the dielectric sheet using the conductive paste for inner electrodes by inkjet printing, screen printing, gravure printing or the like, for example. A dielectric sheet including a first inner electrode pattern formed thereon and a dielectric sheet including a second inner electrode pattern formed thereon are thus prepared. Thereafter, the sheet including the first inner electrode pattern printed thereon and the sheet including the second inner electrode pattern printed thereon are laminated to form a portion to define and function as an inner layer portion 118.

When printing the patterns using each conductive paste, the pattern using the conductive paste for inner electrodes is printed first.

In the case of forming the printing pattern of the inner electrodes by, for example, gravure printing, a gravure plate used in the gravure printing is designed to form a graphic pattern of the first inner electrode and then changed to the structure corresponding to a graphic pattern of the second inner electrode. This makes it possible to form the desired inner electrodes.

Furthermore, in the case of forming the printing pattern of the inner electrodes by screen printing, a screen printing mask is designed to form a graphic pattern of the first inner electrode and then changed to the structure corresponding to a graphic pattern of the second inner electrode. This makes it possible to form the desired inner electrodes.

A predetermined number of dielectric sheets including no inner electrode patterns printed thereon are then laminated to form a portion to define and function as a first outer layer portion 120a on the first surface 112a side. Thereafter, the portion to define and function as the inner layer portion 118 thus prepared is laminated, and the predetermined number of dielectric sheets including no inner electrode patterns printed thereon are laminated on the portion to define and function as the inner layer portion 118 to form a portion to define and function as a second outer layer portion 120b on the second surface 112b side. A multilayer sheet is thus prepared.

Next, the multilayer sheet is pressed in the lamination direction by, for example, an isostatic press or the like to produce a multilayer block.

Then, the multilayer block is cut to a predetermined size, thus cutting out a multilayer chip. In this event, the corners and ridges of the multilayer chip may be rounded by, for example, barrel polishing or the like.

Next, the multilayer chip is fired to produce a multilayer body 112. The firing temperature depends on the ceramic and inner electrode materials, but is, for example, preferably about 900° C. to about 1400° C.

Thereafter, an outer electrode 130 is formed in the multilayer body 112.

The multilayer body 112 including an underlying plating layer 132 formed thereon is placed on a work table, and a thin film layer 134 is formed on the first surface 112a by, for example, sputtering using a predetermined mask.

Then, a surface plating layer 136 is formed on the underlying plating layer 132 and the thin film layer 134 disposed on the surface of the multilayer body 112. More specifically, for example, a Ni plating layer and a Sn plating layer are formed as the surface plating layer 136 on the underlying plating layer 132 and the thin film layer 134. Either electrolytic plating or electroless plating may be used for the plating process. However, electroless plating requires pretreatment with a catalyst or the like to improve the plating deposition speed, resulting in a disadvantage of complicating the process. Therefore, it is usually preferable to use electrolytic plating.

The multilayer ceramic capacitor 110 according to the second example embodiment shown in FIG. 33 can thus be manufactured.

The example method for manufacturing a multilayer ceramic capacitor according to the present example embodiment makes it possible to reduce the thickness of T dimension in the lamination direction x of the outer electrode 130 formed on the first surface 12a. This makes it possible to provide a multilayer ceramic capacitor with a reduced height without impairing mountability during mounting.

### C. Other Modifications

Next, a multilayer ceramic capacitor 210 as another modification of an example embodiment of the present invention will be described.

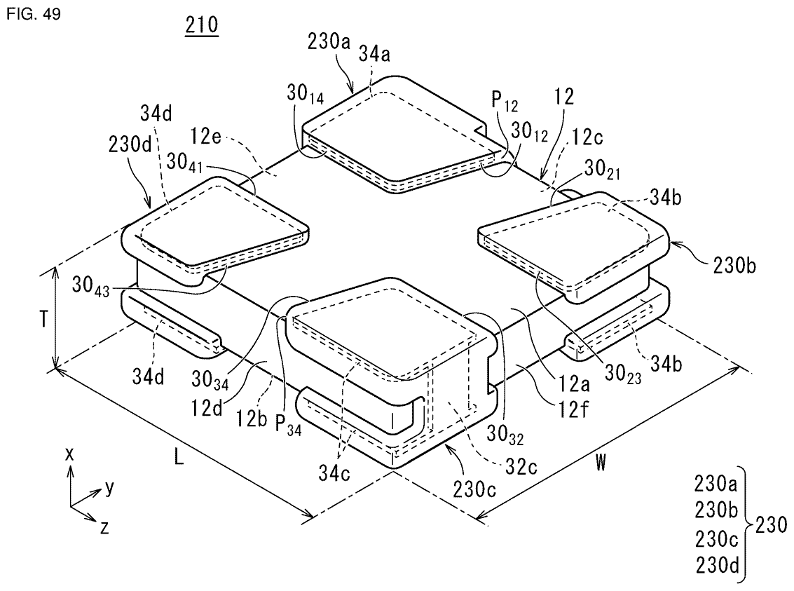

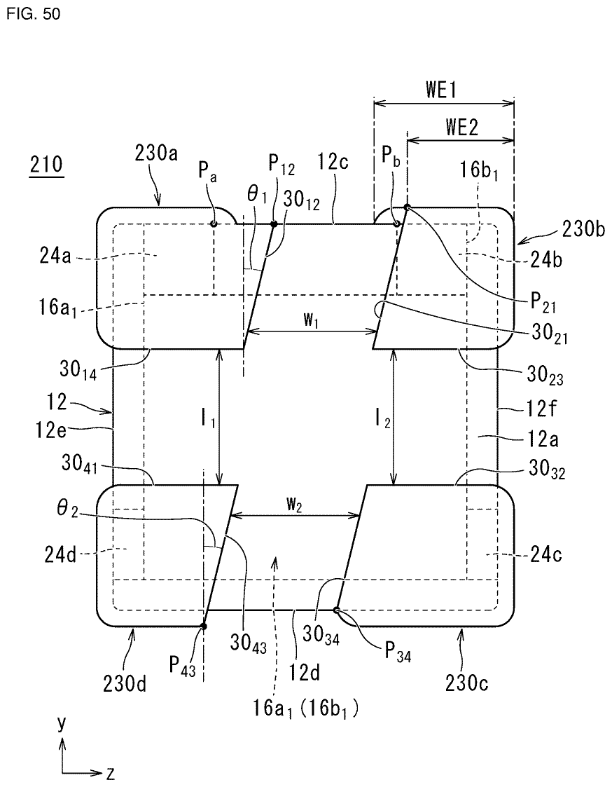

FIG. 49 is an external perspective view showing an example of a multilayer ceramic capacitor according to another modification of an example embodiment of the present invention. FIG. 50 is a plan view showing an example of a multilayer ceramic capacitor according to another modification of an example embodiment of the present invention. However, the same or corresponding configurations as those in FIGS. 1 to 5B will be denoted by the same reference numerals, and detailed description thereof will be omitted.

The multilayer ceramic capacitor 210 according to the present modification is different from the multilayer ceramic capacitor 10 according to the first example embodiment in the shape of an outer electrode 230. In addition, the outer electrode 230 is not disposed on a second surface 12b.

### Inner Electrode

In the multilayer ceramic capacitor 210 according to the present modification, an inner electrode 16 has the same or substantially the same configuration as that of the inner electrode 16 in the multilayer body 12 of the multilayer ceramic capacitor 10 according to the first example embodiment of the present invention shown in FIG. 1.

### Outer Electrode

In the multilayer ceramic capacitor 210 according to the present modification, the outer electrode 230 has the same or substantially the same configuration as that of the outer electrode 30 in the multilayer body 12 of the multilayer ceramic capacitor 10 according to the first example embodiment of the present invention shown in FIG. 1.

The multilayer ceramic capacitor 210 according to the present modification further has the following configuration.

A first outer electrode 230a includes, on the first surface 12a, a side 30₁₂ facing a second outer electrode 230b and a side 30₁₄ facing a fourth outer electrode 230d.

The second outer electrode 230b includes, on the first surface 12a, a side 30₂₁ facing the first outer electrode 230a and a side 30₂₃ facing a third outer electrode 230c.

The third outer electrode 230c includes, on the first surface 12a, a side 30₃₂ facing the second outer electrode 230b and a side 30₃₄ facing the fourth outer electrode 230d.

The fourth outer electrode 230d includes, on the first surface 12a, a side 30₄₁ facing the first outer electrode 230a and a side 30₄₃ facing the third outer electrode 230c.

As illustrated in FIG. 50, it is preferable that the side 30₁₂, the side 30₂₁, the side 30₃₄, and the side 30₄₃ are all inclined in the same direction with respect to the first direction y.

As a result, an end portion P₁₂ of the side 30₁₂ on the third surface 12c side is located at the inner side portion (closer to the center) in the second direction z than an end portion Pₐ of the first inner electrode 16a₁ that is exposed on the third surface 12c. Similarly, an end portion P₃₄ of the side 30₃₄ on the fourth surface 12d side is located at the inner side portion (closer to the center) in the second direction z than an end portion P_{b} of the second inner electrode 16b₁ that is exposed on the third surface 12c.

On the other hand, an end portion P₂₁ of the side 30₂₁ on the third surface 12c side is located at the outer side portion in the second direction z than the end portion P_{b} of the second inner electrode 16b₁ that is exposed on the third surface 12c. Similarly, an end portion P₄₃ of the side 30₄₃ on the fourth surface 12d side is located at the outer side portion in the second direction z than the end portion Pₐ of the first inner electrode 16a₁ that is exposed on the third surface 12c.

As a result, the self-alignment properties of the multilayer ceramic capacitor 210 when mounted by soldering in the first direction y can further improve mountability of the capacitor.

It is preferable that the sides 30₁₂ and 30₄₃ have inclination angles θ₁ and θ₂ of, for example, about 3° to about 15° with respect to the first direction y and are inclined in the same direction.

As a result, the self-alignment properties of the multilayer ceramic capacitor 210 when mounted by soldering in the first direction y can further improve the mountability of the capacitor.

The end portion of the side 30₂₁ on the third surface 12c side is located at the outer side portion in the second direction z, with respect to the length of the second outer electrode 230b disposed on the third surface 12c, than the end portion at the inner side portion in the second direction z of the second outer electrode 230b disposed on the third surface 12c. Here, WE1 is the distance in the second direction z of the second outer electrode 230b when viewed from the lamination direction x. WE2 is the distance in the second direction z between the end portion P₂₁ of the side 30₂₁ on the third surface 12c side and the outermost end in the second direction z of the second outer electrode 230b. In this case, the ratio of WE2 to WE1 is, for example, preferably about 54% to about 98%.

This allows the multilayer ceramic capacitor 210 to be stably attracted and held in the case of mounting the multilayer ceramic capacitor 210 using a mount machine or the like.

It is preferable that the absolute value of the difference between a distance w₁ in the second direction z between the first outer electrode 230a and the second outer electrode 230b and a distance w₂ in the second direction z between the third outer electrode 230c and the fourth outer electrode 230d is, for example, less than or equal to about 5 μm.

It is preferable that the absolute value of the difference between a distance l₁ in the first direction y between the first outer electrode 230a and the fourth outer electrode 230d and a distance l₂ in the first direction y between the second outer electrode 230b and the third outer electrode 230c is, for example, less than or equal to about 5 μm.

It is preferable that the absolute value of the difference between the distance w₁ in the second direction z between the first outer electrode 230a and the second outer electrode 230b and the distance l₁ in the second direction z between the first outer electrode 230a and the fourth outer electrode 230d is, for example, less than or equal to about 5 μm.

The multilayer ceramic capacitor 210 shown in FIG. 49 has the same or substantially the same advantageous effects as those of the multilayer ceramic capacitor 10 according to the first example embodiment, and also has the following advantageous effects.

Specifically, in the multilayer ceramic capacitor 210, the side 30₁₂, the side 30₂₁, the side 30₃₄, and the side 30₄₃ are all inclined in the same direction with respect to the first direction y, and the dimension L of the multilayer body 12 in the first direction y and the dimension W thereof in the second direction z satisfy about 0.85≤L/W≤about 1.00, for example. The first outer electrode 230a and the third outer electrode 230c disposed on the first surface 12a each extend towards the center in the second direction z, thus making it possible to improve the self-alignment properties of the multilayer ceramic capacitor 210 during mounting.

A multilayer ceramic capacitors according to an example embodiment of the present invention may also have a configuration described below.

Specifically, when viewed in the lamination direction x, the outer electrode 230 may include a first recess portion extending in the first direction y inside the multilayer body 12. The outer electrode 230 may include a second recess portion extending in the second direction z inside the multilayer body 12.

More specifically, in the case where the first outer electrode 230a covers the first surface 12a, the second surface 12b, the third surface 12c, and the fifth surface 12e, the first outer electrode 230a may include the second recess portion extending in the second direction z on the third surface 12c side and the first recess portion extending in the first direction y on the fifth surface 12e side, when viewed in the lamination direction x from the first surface 12a side.

Similarly, in the case where the first outer electrode 230a covers the first surface 12a, the second surface 12b, the third surface 12c, and the fifth surface 12e, the first outer electrode 230a may include the second recess portion extending in the second direction z on the third surface 12c side and the first recess portion extending in the first direction y on the fifth surface 12e side, when viewed in the lamination direction x from the second surface 12b side.

The second outer electrode 230b to the fourth outer electrode 230d may also include recess portions as described above.

As described above, the example embodiments of the present invention have been disclosed in the above description, but the present invention is not limited thereto.

Various changes can be made to the example embodiments described above in terms of mechanism, shape, material, quantity, position, arrangement, or the like without departing from the scope and purpose of the present invention, and these are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface facing each other in a lamination direction, a third surface and a fourth surface facing each other in a first direction orthogonal or substantially orthogonal to the lamination direction, and a fifth surface and a sixth surface facing each other in a second direction orthogonal or substantially orthogonal to the lamination direction and the first direction;
a first outer electrode on the first surface, the third surface, and the fifth surface;
a second outer electrode on the first surface, the third surface, and the sixth surface;
a third outer electrode on the first surface, the fourth surface, and the sixth surface; and
a fourth outer electrode on the first surface, the fourth surface, and the fifth surface; wherein
the multilayer body includes a first inner electrode exposed on the third surface and a surface other than the third surface and connected to the first outer electrode and the third outer electrode;
the first outer electrode includes a notch portion that opens toward the fifth surface; and
about 0.85≤L/W≤about 1.0 is satisfied, where L is a dimension in the first direction and W is a dimension in the second direction.

2. The multilayer ceramic capacitor according to claim 1, wherein the second outer electrode includes a notch portion that opens toward the sixth surface.

3. The multilayer ceramic capacitor according to claim 1, wherein the third outer electrode includes a notch portion that opens toward the fourth surface.

4. The multilayer ceramic capacitor according to claim 1, wherein the fourth outer electrode includes a notch portion that opens toward the fourth surface.

5. The multilayer ceramic capacitor according to claim 1, wherein
the first outer electrode includes:
a first underlying plating layer directly connected to the first inner electrode;
a first thin film layer on the first surface; and
a first surface plating layer on the first underlying plating layer and the first thin film layer.

6. The multilayer ceramic capacitor according to claim 5, wherein, on the first surface, the first outer electrode includes:
a side A of the first outer electrode facing the fourth outer electrode; and
a side B of the first outer electrode facing the second outer electrode;
the second outer electrode includes:
a side C of the second outer electrode facing the first outer electrode; and
a side D of the second outer electrode facing the third outer electrode;
the third outer electrode includes:
a side E of the third outer electrode facing the second outer electrode; and
a side F of the third outer electrode facing the fourth outer electrode;
the fourth outer electrode includes:
a side G of the fourth outer electrode facing the third outer electrode; and
a side H of the fourth outer electrode facing the first outer electrode; and
the side B, the side C, the side F, and the side G are inclined in a same direction with respect to the first direction.

7. The multilayer ceramic capacitor according to claim 5, wherein
the first outer electrode includes:
a first recess portion located at an inner side portion of the multilayer body, the first recess portion including a dimension in the first direction longer than a dimension in the second direction.

8. The multilayer ceramic capacitor according to claim 2, wherein the third outer electrode includes a notch portion that opens toward the fourth surface.

9. The multilayer ceramic capacitor according to claim 8, wherein the fourth outer electrode includes a notch portion that opens toward the fourth surface.

10. The multilayer ceramic capacitor according to claim 2, wherein the fourth outer electrode includes a notch portion that opens toward the fifth surface.

11. The multilayer ceramic capacitor according to claim 4, wherein the third outer electrode includes a notch portion that opens toward the sixth surface.

12. The multilayer ceramic capacitor according to claim 4, wherein the second outer electrode includes a notch portion that opens toward the third surface.

13. The multilayer ceramic capacitor according to claim 11, wherein the second outer electrode includes a notch portion that opens toward the third surface.

14. The multilayer ceramic capacitor according to claim 1, wherein the first outer electrode includes a notch portion that opens toward the third surface.

15. The multilayer ceramic capacitor according to claim 14, wherein the first outer electrode includes a notch portion that opens toward the sixth surface.

16. The multilayer ceramic capacitor according to claim 15, wherein the first outer electrode includes a notch portion that opens toward the fourth surface.

17. The multilayer ceramic capacitor according to claim 15, wherein the notch portion that opens toward the fifth surface is larger than the notch portion that opens toward the sixth surface.

18. The multilayer ceramic capacitor according to claim 15, wherein the notch portion that opens toward the fifth surface is deeper than the notch portion that opens toward the sixth surface.

19. A multilayer ceramic capacitor comprising:
a multilayer body including a first surface and a second surface facing each other in a lamination direction, a third surface and a fourth surface facing each other in a first direction orthogonal or substantially orthogonal to the lamination direction, and a fifth surface and a sixth surface facing each other in a second direction orthogonal or substantially orthogonal to the lamination direction and the first direction;
a first outer electrode on the first surface, the third surface, and the fifth surface;
a second outer electrode on the first surface, the third surface, and the sixth surface;
a third outer electrode on the first surface, the fourth surface, and the sixth surface; and
a fourth outer electrode on the first surface, the fourth surface, and the fifth surface; wherein
the multilayer body includes a first inner electrode exposed on the third surface and a surface other than the third surface and connected to the first outer electrode and the third outer electrode;
the first outer electrode includes a recess portion on the third surface and the fifth surface; and
about 0.85≤L/W≤about 1.0 is satisfied, where L is a dimension in the first direction and W is a dimension in the second direction.

20. A multilayer ceramic capacitor comprising:
a multilayer body including a first surface and a second surface facing each other in a lamination direction, a third surface and a fourth surface facing each other in a first direction orthogonal or substantially orthogonal to the lamination direction, and a fifth surface and a sixth surface facing each other in a second direction orthogonal or substantially orthogonal to the lamination direction and the first direction;
a first outer electrode on the first surface, the third surface, and the fifth surface;
a second outer electrode on the first surface, the third surface, and the sixth surface;
a third outer electrode on the first surface, the fourth surface, and the sixth surface; and
a fourth outer electrode on the first surface, the fourth surface, and the fifth surface; wherein
the multilayer body includes a first inner electrode exposed on the third surface and a surface other than the third surface and connected to the first outer electrode and the third outer electrode;
a ridge portion between the third surface and the fifth surface is exposed from the first outer electrode; and
about 0.85≤L/W≤about 1.0 is satisfied, where L is a dimension in the first direction and W is a dimension in the second direction.
